(19) United States
(12) Patent Application Publication
(10) Pub. No.: US 2026/0087699 A1
(43) Pub. Date: Mar. 26, 2026

(54) LOCATION MODELING FOR LOCALIZED OBJECT INSERTION

(71) Applicant: QUALCOMM Incorporated, San Diego, CA (US)

(72) Inventors: Jooyeol YUN, Seongnam-si (KR); Davide ABATI, Amsterdam (NL); Mohamed OMRAN, Amsterdam (NL); Auke Joris WIGGERS, Amsterdam (NL)

(21) Appl. No.: 18/991,199

(22) Filed: Dec. 20, 2024

Related U.S. Application Data
(60) Provisional application No. 63/698,516, filed on Sep. 24, 2024.

(51) Int. Cl. G06T 11/60; G06V 10/764; G06V 10/82; G06V 20/20; G06V 20/70

(52) U.S. Cl. CPC G06T 11/60; G06V 10/764; G06V 10/82; G06V 20/20; G06V 20/70; G06T 2200/24; G06T 2210/12

(57) ABSTRACT

Systems and techniques are described herein for determining bounding box coordinates. For example, a computing device can process an image to generate a first plurality of tokens associated with the image. The computing device can process, using a first machine learning model, the first plurality of tokens and a class token associated with a class of an object to generate a probability distribution associated with coordinates of a bounding box within the image. The computing device can determine, based on the probability distribution, target coordinates to position the bounding box within the image.

### CROSS-REFERENCE TO RELATED APPLICATIONS

This application claims the benefit of U.S. Provisional Patent Application No. 63/698,516, filed on Sep. 24, 2024, which is hereby incorporated by reference, in its entirety and for all purposes.

### TECHNICAL FIELD

The present disclosure generally relates to location modeling. For example, aspects of the disclosure relate to systems and techniques for location modeling for localized object insertion into images (e.g., to identify probable bounding box locations for adding visual representations of objects to images).

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Machine learning models (e.g., artificial neural network models) can be used to generate realistic images and/or to edit real or artificially generated images (e.g., to add content to one or more locations in images). However, editing images using machine learning models can require human intervention (e.g., to manually provide locations for edit). Such a solution does not scale well to large scale editing. Also, the quality of the edits depends on specified input locations.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for image processing is provided. The apparatus includes at least one memory and at least one processor coupled to the at least one memory and configured to: process an image to generate a first plurality of tokens associated with the image; process, using a first machine learning model, the first plurality of tokens and a class token associated with a class of an object to generate a probability distribution associated with coordinates of a bounding box within the image; and determine, based on the probability distribution, target coordinates to position the bounding box within the image.

In some aspects, a method for image processing is provided. The method includes: processing an image to generate a first plurality of tokens associated with the image; processing, using a first machine learning model, the first plurality of tokens and a class token associated with a class of an object to generate a probability distribution associated with coordinates of a bounding box within the image; and determining, based on the probability distribution, target coordinates to position the bounding box within the image.

In some aspects, a non-transitory computer-readable medium is provided having stored thereon instructions that, when executed by at least one processor, cause the at least one processor to: process an image to generate a first plurality of tokens associated with the image; process, using a first machine learning model, the first plurality of tokens and a class token associated with a class of an object to generate a probability distribution associated with coordinates of a bounding box within the image; and determine, based on the probability distribution, target coordinates to position the bounding box within the image.

In some aspects, an apparatus for image processing is provided. The apparatus includes: means for processing an image to generate a first plurality of tokens associated with the image; means for processing the first plurality of tokens and a class token associated with a class of an object to generate a probability distribution associated with coordinates of a bounding box within the image; and means for determining, based on the probability distribution, target coordinates to position the bounding box within the image.

An apparatus for image processing is provided. The apparatus includes at least one memory and at least one processor coupled to the at least one memory and configured to: process an image to generate a first plurality of tokens associated with the image; process, using a first machine learning model, the first plurality of tokens and a class token associated with a class of an object to generate a probability distribution associated with coordinates of a bounding box within the image; determine, based on the probability distribution, target coordinates to position the bounding box within the image; and add a visual representation of the object to the image within the target coordinates of the bounding box. In some cases, the apparatus can be part of an extended reality (XR) device that includes: at least one camera configured to capture an image of the real-world environment as the image; and at least one display configured to display a modified image after adding the visual representation of the object to the image within the target coordinates of the bounding box.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

FIG. 1 is a block diagram illustrating an architecture of an example system on a chip (SOC) for performing location modeling, according to aspects of the disclosure;

FIGS. 2A-2E are block diagrams illustrating systems for performing location modeling, according to aspects of the disclosure;

FIG. 3 is a block diagram illustrating an example machine learning model for adding a visual representation of an object to an image, according to aspects of the disclosure;

FIG. 4 is a block diagram illustrating an example training system for training a machine learning model for performing location modeling, according to aspects of the disclosure;

FIG. 5 is a block diagram illustrating an example training system for training a machine learning model for location modeling using preference alignment of bounding box coordinates, according to aspects of the disclosure;

FIG. 6 is a block diagram illustrating another example training system for training a machine learning model for location modeling, according to aspects of the disclosure;

FIG. 7 is a block diagram illustrating another example machine learning model for adding a visual representation of an object to an image, according to aspects of the disclosure;

FIG. 8A is a block diagram illustrating example training data for training a machine learning model for performing location modeling, according to aspects of the disclosure;

FIG. 8B is a diagram illustrating an illustrative example of an extended-reality (XR) system providing a technical application of the systems and techniques described herein, according to aspects of the disclosure;

FIG. 9 is a flow diagram for an example process for performing location modeling, according to aspects of the disclosure;

FIG. 10 is a block diagram illustrating an example of a deep learning neural network that can be used to perform various tasks, according to aspects of the disclosure;

FIG. 11 is a block diagram illustrating an example of a convolutional neural network (CNN), according to aspects of the disclosure;

FIG. 12 is a block diagram of an example transformer, according to aspects of the disclosure; and

FIG. 13 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As noted previously, machine learning models (e.g., artificial neural network models) can be used to edit real images (e.g., captured using a camera) and/or artificially generated images, e.g., generated by one or more machine learning models. For example, a machine learning model can add content to one or more locations in an image. Spatial awareness (e.g., the ability to determine where synthetic objects can be placed within a scene) is crucial for creating realistic images when editing images. Machine learning models with improved spatial awareness improve the quality of edits. Machine learning models with improved spatial awareness can be used in applications where placement of synthetic objects (e.g., visual representations of objects) is performed, such as in applications incorporating extended reality (XR) (e.g., augmented reality (AR), virtual reality (VR), and/or mixed reality (MR)) and/or and virtual environments, robotics, vehicle navigation (e.g., for autonomous or semi-autonomous vehicles), among other applications. Machine learning models can perform location modeling to determine spatial relationships between objects and an environment. The spatial awareness can be used to integrate new synthetic (e.g., virtual) objects or other visual elements convincingly into an image.

Object insertion into images is a challenging task for machine learning models. In some cases, object insertion can include multiple sub-tasks. For example, object insertion can include a first sub-task for determining where to place an object (e.g., a synthetic object) without disrupting visual coherence of an image. Object insertion can also include determining a precise location to insert the object while preserving visual integrity of the background of the image. Object insertion can include a second sub-task of generating the object in a visually realistic manner consistent with the visual coherence of the image.

Instruction-tuned image editing approaches address the two aforementioned subtasks with a single machine learning model, which implicitly determines the location during a generation process (e.g., when generating an image and/or editing an image). Instruction-tuned image editing models often lack spatial awareness, leading to undesirable changes in unrelated areas of the image or replacing existing objects during object insertion. Changes in unrelated areas generally include generation of unintended artifacts which can be markers that an image has been edited and fails to seamlessly insert an object into an image without altering the original scene.

Current machine learning models lack an accurate approach for determining where to insert an object. For example, training machine learning models to determine where to insert an object into an image is difficult. For example, training data (e.g., images) must include dense annotations (e.g., relatively dense with annotations) because objects can be inserted into images at various orientations, sizes, and locations. Generally, machine learning models use a bounding box, which is an area of an image generally represented by a rectangle box, where the machine learning model may insert an object. Unlike object detection or segmentation tasks, where annotating all existing entities results in a dense annotation of the scene, training a machine learning model to annotate all plausible (positive) and implausible (negative) locations to insert objects can be difficult due to a vast number of potential bounding boxes within the image.

Some machine learning models include training a discriminative location model (e.g., a classifier or an object detector), such as by treating non-labeled locations as negative examples or customizing loss functions to reduce penalties for unlabeled locations. Training a machine learning model by penalizing unlabeled positions can require dense annotation of training data because the machine learning model can penalize locations that would be positive but were unlabeled, thereby making the accuracy of the machine learning model sensitive to the density of annotations of the training data.

The problems introduced in instruction-tuned image editing can be avoided by breaking object insertion tasks into two distinct steps. The first step includes determining the precise location of the object. The second step includes performing a localized edit at the location. However, for object insertion to be implemented in certain systems (e.g., XR systems, robotics systems, vehicle systems, etc.), the two tasks must be performed accurately enough so that the resulting image depicts a plausible object in the image and must be performed fast enough to be implementable in real world scenarios. Because of such constraints, the two-step approach can be difficult to implement.

Systems, apparatuses, methods (also referred to as processes), and computer-readable media (collectively referred to herein as “systems and techniques”) are described herein that provide location modeling for localized object insertion (into one or more images). For example, a machine learning model can be used to predict bounding box locations in an image based on the object to be inserted (e.g., based on a class of the object, a type of the object, a name of the object, or other identifying information associated with the object). In some cases, the systems and techniques described herein can leverage a machine learning model, such as a generative machine learning model (e.g., a large language model (LLM)), to perform location modeling (e.g., generative location modeling) via autoregressive decoding. In some cases, the systems and techniques described herein can reduce background distortions while maintaining high-quality object generation.

According to some aspects, during inference (e.g., after the machine learning model has been trained), the machine learning model can receive tokenizations of an image (e.g., tokens generated from an image, such as visual tokens) and tokenizations of an object class (e.g., a token generated for the object class) for an object that is to be added to the image. The machine learning model can concatenate the tokenizations of the image and object class to generate a series of tokens. The machine learning model can generate probability distributions associated with the series of tokens. The probability distributions can indicate different probabilities of bounding box coordinates for locating the bounding box. The machine learning model can repeat the generation of probability distributions for additional series of tokens for different bounding box coordinates. Based on the probability distributions, the machine learning model can select coordinates of a bounding box to insert an object associated with the object class. For example, the machine learning model can select the bounding box coordinates associated with the highest probability. In some cases, during training of the machine learning model, the machine learning model can receive tokenization of bounding box coordinates (e.g., tokens generated from coordinate values). The machine learning model can concatenate the tokenizations of the image and object class with the bounding box coordinates to generate a series of tokens used to train the machine learning model, as described herein. While examples described herein use bounding boxes for illustrative purposes, bounding regions of other shapes may be used, such as a square, an ellipse, or other shape.

In some aspects, the machine learning model can be a generative model, such as an autoregressive transformer. The generative model can receive an image and an object class selection (e.g., a class associated with the object to be inserted into an image) and can generate coordinates associated with a bounding box. In some examples, the machine learning model generates the coordinates of the bounding box (e.g., during training) instead of or in addition to receiving bounding box coordinates. In some examples, the machine learning model can use a random number generator to generate one or more coordinates of a bounding box.

In some cases, the coordinates of the bounding box can be normalized relative to a coordinate system of the image. In some examples, normalization can include setting a coordinate system from 0 to 1 for x-coordinates and −1 to 0 for y-coordinates of the image. In such an example, coordinate (0,0) can represent the top left corner of the image, coordinate (0, −1) can represent the bottom left corner of the image, coordinate (1, −1) can represent the bottom right corner of the image, coordinate (0.5, −0.5) can represent the center of the image, etc. In some examples, a bounding box can include four coordinates (e.g., two x-coordinates and two y-coordinates). The bounding box can represent an area of the image within a box (e.g., rectangle) formed by the four coordinates.

As noted above, the machine learning model can receive tokenizations of an image. For instance, the machine learning model can process the image to generate a token representation of the image, referred to as visual tokens. In some examples, the machine learning model can tokenize the image by generating (two-dimensional) patches representing segments (e.g., non-overlapping areas) of the image. For example, machine learning model can segment the image into patches, such as in 8×8 pixel areas, and can process the patches to generate vectors (e.g., a one-dimensional vector including numerical values) representing the patches. In further examples, the machine learning model can tokenize the coordinates of the bounding box. In some cases, the coordinates (e.g., x-coordinate values, y-coordinate values) are already tokens. In further examples, the machine learning model can tokenize the object class selection. In some examples, the object class selection received by the machine learning model is already a token.

In some aspects, the object class selection can be represented as a one-hot class embedding vector. For example, the one-hot class embedding vector can be a zero vector with a single value (e.g., a 1) in one element of the vector. Each element of the one-hot class embedding vector can be associated with a different object or class of objects. For example, a first element of the vector can be associated with a food, another element associated with a vehicle, and another element associated with an electronic device. In further examples, the element can be more specific, such as a “doughnut”, a “bicycle”, and a “laptop”. In further examples, the user can select the object class (e.g., user class selection). For example, the user can provide input to a user interface associated with or incorporating the machine learning model to select an object to add to an image. The machine learning model can receive the selection. In another example, the object class selection can be represented by a string description. In such an example, the string description can be turned into a token (or plurality of tokens) by a language model encoder such as a Contrastive Language-Image Pre-training (CLIP) text encoder.

During inference, the machine learning model can process the tokens representing the image and the token(s) representing the object class of the object to be inserted into the image to determine a distribution of probabilities associated with bounding box coordinates. The machine learning model can determine, based on the distribution of probabilities, a probable location (e.g., coordinates) of a bounding box within the image.

The machine learning model can output the probable location, or multiple probable locations, of the bounding box for object insertion. In some aspects, an additional machine learning model can use various in-painting techniques to insert the object into the image based on the location of the bounding box. For example, the additional machine learning model can use in-painting techniques and algorithms such as PowerPaint, as for instance described in section 3 of the preprint “A Task is Worth One Word: Learning with Task Prompts for High-Quality Versatile Image Inpainting” by J. Zhuang et al., arXiv preprint arXiv:2312.03594, 2023.

In some aspects, the probabilities determined by the machine learning model are conditional probabilities. For example, the probabilities can be conditional based on the location of a first coordinate. The machine learning model can determine the conditional probability for each subsequent coordinate of the bounding box. For example, the machine learning model can determine a probability associated with a first x-coordinate of the bounding box being located at a first location of the image. The machine learning model can determine a conditional probability of the location of a first y-coordinate being located at a second location based on the first x-coordinate being located at the first location. The machine learning model can determine conditional probabilities for subsequent coordinates of the bounding box.

The machine learning model can determine conditional probabilities for additional samples of coordinates. For example, the machine learning model can determine conditional probabilities for multiple samples of coordinates (e.g., coordinates for multiple bounding boxes). In some cases, the machine learning model can generate a histogram representing probabilities of bounding boxes at different coordinates. The machine learning model can determine, based on the histogram, target coordinates of the bounding box. For example, the target coordinates can represent a most probable location for a bounding box to be located. In some aspects, the machine learning model is an autoregressive model that sequentially generates probabilities or predictions associated with the coordinates of the bounding box.

The machine learning model can be trained using positive examples (e.g., training images including bounding boxes associated with a class) of bounding boxes placed in images. In some cases, during training, the machine learning model can process coordinates representing bounding boxes at various coordinates of the image to determine a distribution of probabilities that are used to train the machine learning model. In some examples, training can include encoding the coordinates by normalizing the coordinates into a fixed range (e.g., 0 to 1, −1 to 0, etc.). The training can further include quantizing the normalized coordinates into equally spaced bins. In some examples, the training process can include tokenizing images and object class selections using a model (e.g., a visual encoder) that parses images and produces tokens. For instance, in some cases, the training process can include tokenizing images and object class selections using a pre-trained vision transformer (e.g., a vision transformer (ViT), such as the transformer described in section 3 of the preprint “An Image is Worth 16×16 Words: Transformers for Image Recognition at Scale” by A. Dosovitskiy et al., International Conference on Learning Representations, 2021, or Contrastive Language-Image Pre-training (CLIP)), as for instance described in sections 1 and 2 of the article “Learning Transferable Visual Models From Natural Language Supervision” by A. Radford et al., International Conference on Machine Learning, pp. 8748-8763, PMLR, 2021, a CLIP text encoder, a transformer-based neural network model (e.g., a large language model (LLM), any combination thereof, and/or other model. The visual tokens and the token associated with an object class selection can be prepended while the machine learning model is trained to sequentially predict coordinates of a bounding box.

In some examples, the machine learning model can be trained on negative and positive annotations. For example, training data can include coordinates for where a bounding box should not be located (e.g., negative annotations) and coordinates for where a bounding box could be located (e.g., positive annotations). The machine learning model can use the negative and positive annotations of the training data as a preference dataset where locations associated with positive labels are implicitly preferred over locations associated with negative labels. Training can include fine-tuning the machine learning model with direct preference optimization (DPO) techniques and penalizing high logits assigned to negative annotations. Various aspects of the application will be described with respect to the figures below.

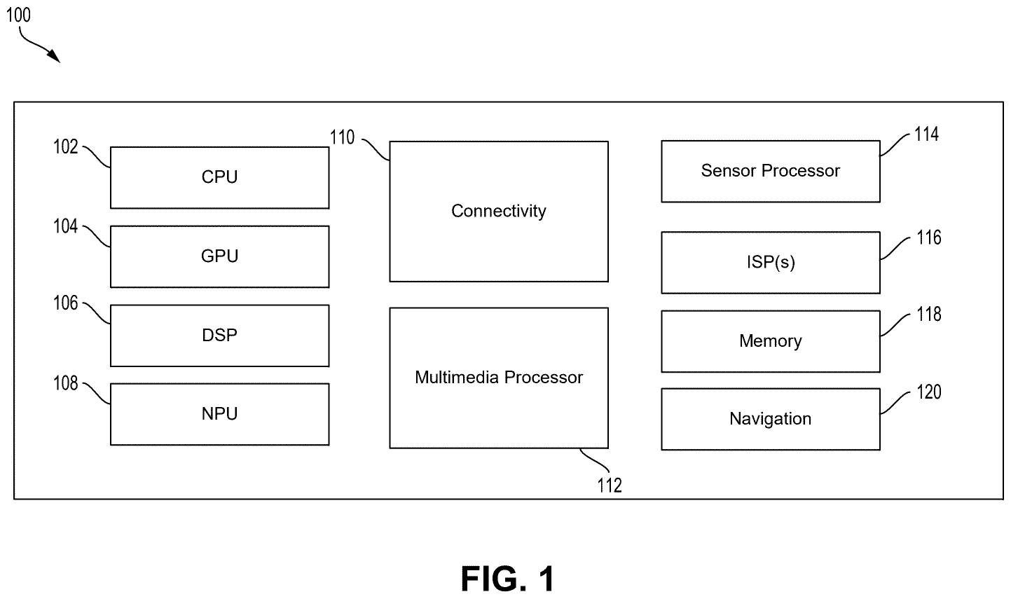

FIG. 1 illustrates an example implementation of a system-on-a-chip (SOC) 100, which can include a central processing unit (CPU) 102 or a multi-core CPU, configured to perform one or more of the functions described herein. Parameters or variables (e.g., neural signals and synaptic weights), system parameters associated with a computational device (e.g., artificial neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

The SOC 100 can also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. SOC 100 and/or components thereof may be configured to perform segmentation mask extrapolation. For example, the CPU 102, DSP 106, and/or GPU 104 may be configured to perform object detection using a visual language model via latent feature adaptation with synthetic data.

In some cases, the SOC 100 may process data using neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles can benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer can be referred to as a feedback (or top-down) connection. A network with many feedback connections may be helpful when the recognition of a high-level concept may aid in discriminating the particular low-level features of an input. The connections between layers of a neural network may be fully connected or locally connected.

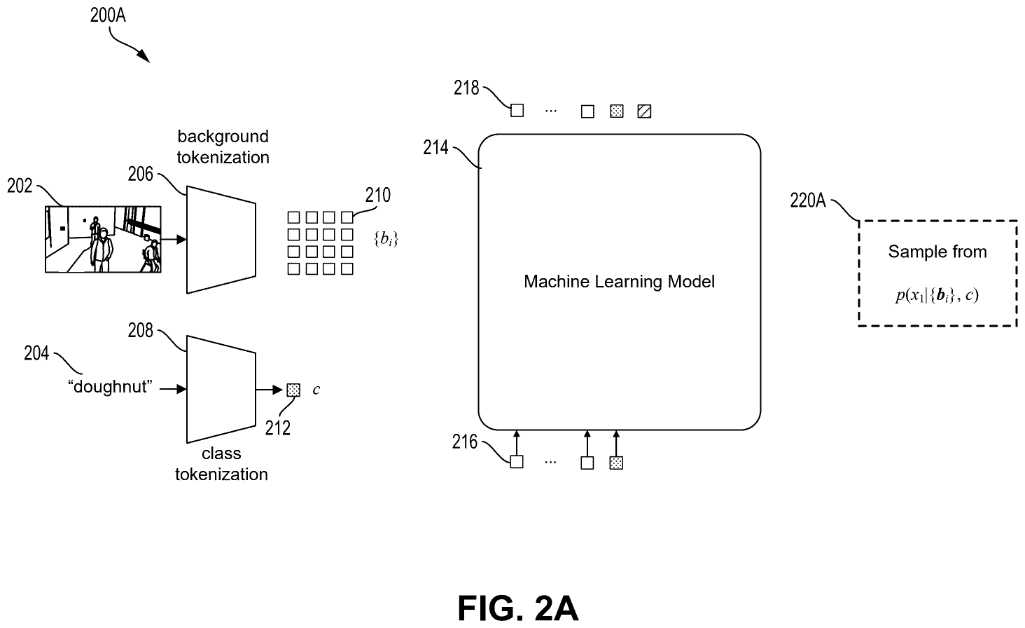

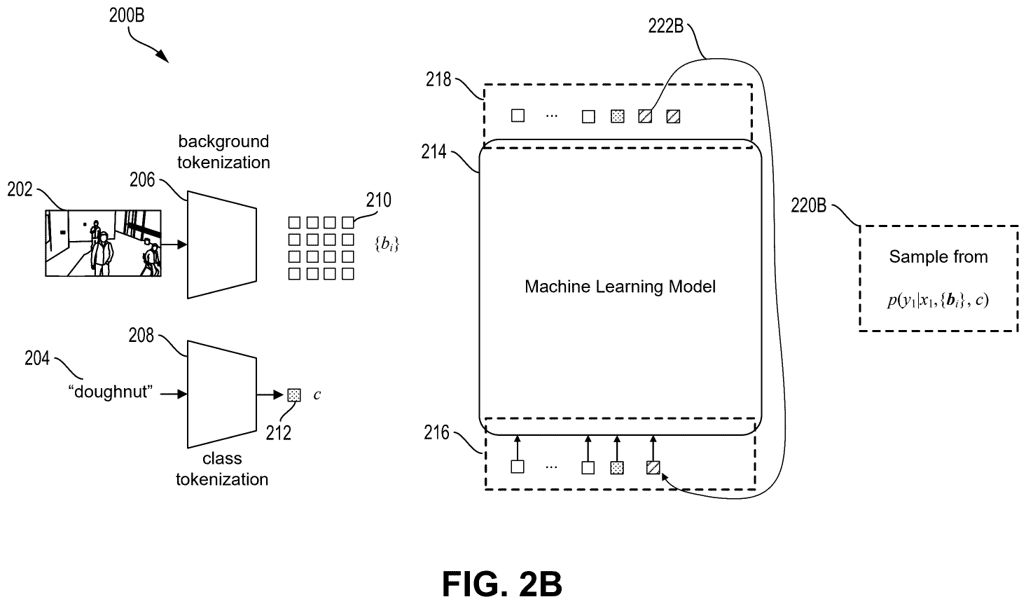

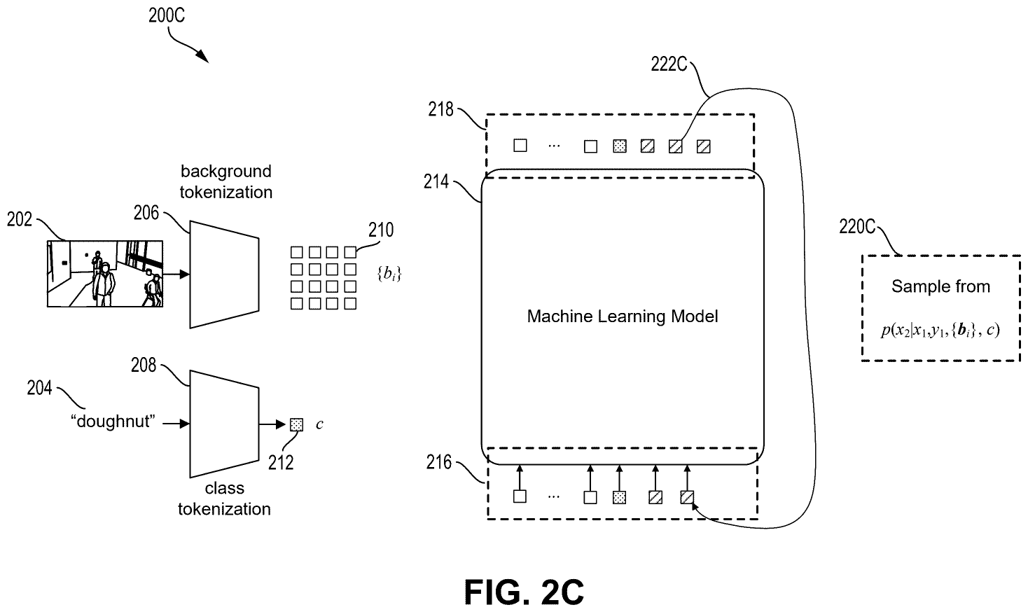

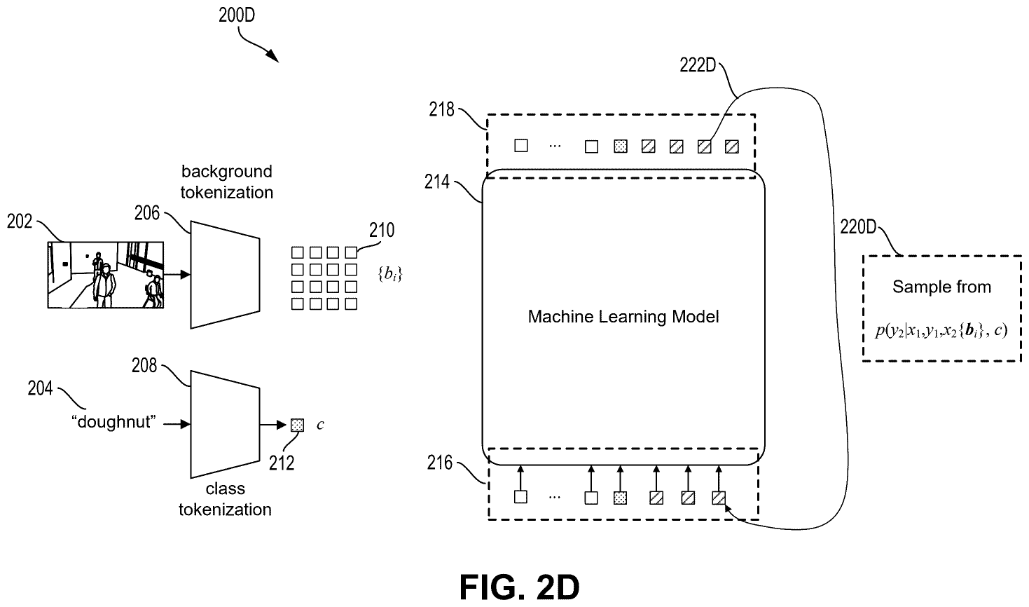

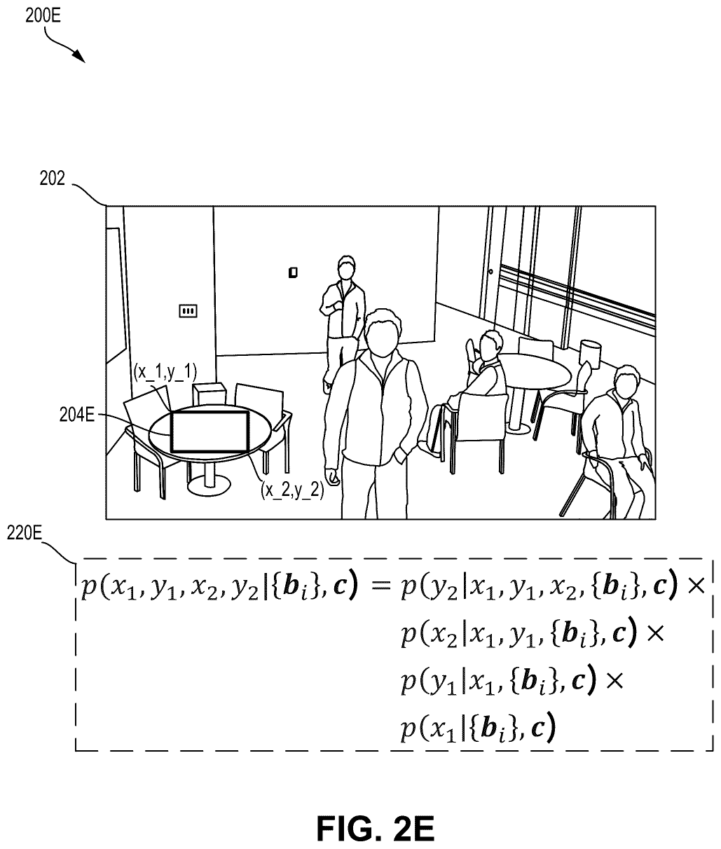

In some aspects, the SOC 100 of FIG. 1 can process data using neural networks and/or machine learning (ML) systems such as the machine learning model 214 of FIGS. 2A-2D, FIGS. 3-6, and FIGS. 8-10.

FIG. 2A is a block diagram illustrating a system 200A for performing location modeling. System 200A includes a machine learning model 214, a first encoder 206, and a second encoder 208. In some examples, the first encoder 206 and the second encoder 208 are part of the machine learning model 214.

The first encoder 206 can be an image encoder for processing an image into a plurality of image tokens. For example, the first encoder 206 can receive and tokenize an image 202. The first encoder 206 can process the image 202 to generate a token representation of the image 202, referred to as visual tokens 210 or image tokens (denoted as {bᵢ}). In some examples, the first encoder 206 can tokenize the image by generating patches representing non-overlapping areas of the image, such as different sections of the image. For instance, the first encoder 206 can segment the image 202 into a distribution of patches of uniform area. The first encoder 206 can process the patches by generating vector representations of the patches.

The second encoder 208 can receive an object class selection 204. For example, the object class selection 204 can be selected by a user as the object the user intends to insert into the image 202. In some examples, the object class selection 204 is a text, such as a word representing the object to be inserted into the image 202 (e.g., doughnut). In further examples, the object class selection can be represented as a one-hot class embedding vector. The one-hot class embedding vector can be preset such that each element of the one-hot class embedding vector is associated with a different object or class of objects. The one-hot class embedding vector can be a vector of zeroes with a single 1 value for the object or class of objects selected to be inserted in the image 202. For example, a first element of the vector can be associated with a doughnut, the second element of the vector can be associated with pizza, etc. In some examples, the second encoder 208 can tokenize a text input or the one-hot class embedding vector to the second encoder 208 to generate an object class token 212 (also referred to as a class token).

The machine learning model 214 can process the visual tokens and the object class token to generate a series of tokens. For example, the machine learning model 214 can concatenate the visual tokens and the object class token by appending the object class token to the end of a series of representation of the visual tokens.

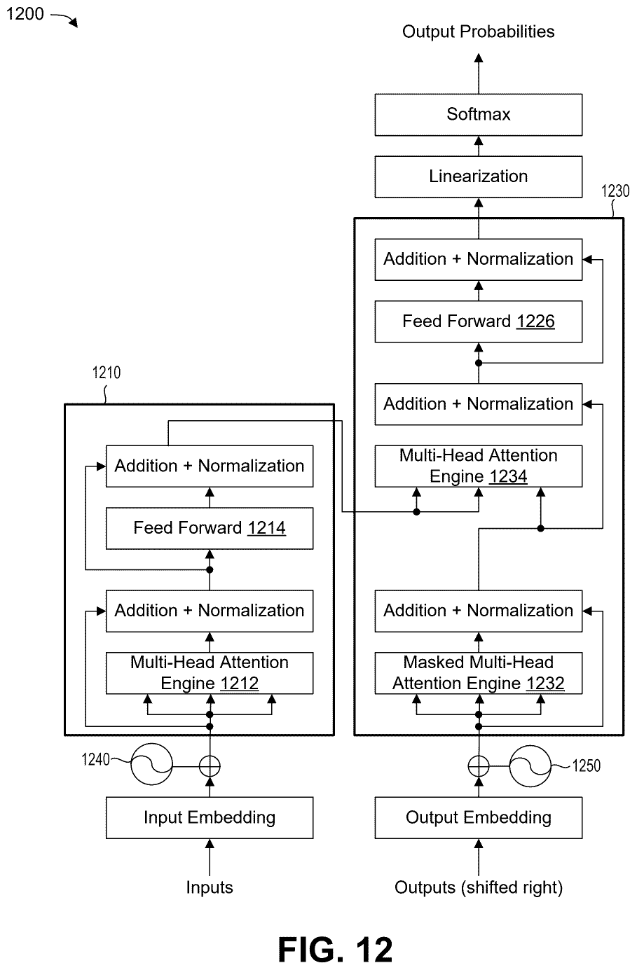

The machine learning model 214 can generate random or preset bounding box coordinates. In some examples, the machine learning model can use a random number generator to generate one or more coordinates of a bounding box. In some aspects, the machine learning model 214 can be a generative model, such as a transformer shown in FIG. 12, or an autoregressive transformer. The machine learning model 214 can receive visual tokens 210 and an object class token 212 to generate predictions of where coordinates of a bounding box could be placed for performing object insertion in the image 202. The prediction can be conditional probabilities associated with the location of bounding box coordinates. For example, inputs 216 to the machine learning model 214 includes the visual tokens 210 and the object class token 212.

Based on the inputs 216, the machine learning model 214 generates output 218 including coordinate locations for a bounding box. The coordinates of the bounding box are then provided as input to the machine learning model 214 to determine additional coordinates of the bounding box. The machine learning model 214 generates conditional probabilities (e.g., a probability distribution) associated with the coordinates generated by the machine learning model 214 representing a probability that the coordinates would be placed at locations within the image 202. For example, a first probability 220A associated with a first coordinate can be represented as p(x₁|{bᵢ},c). Element x₁ represents a first x-coordinate of the bounding box, {bᵢ} represents the visual tokens 210, and c represents the object class token 212.

In some examples, the machine learning model 214 can receive the coordinates from a separate component or separate machine learning model. In some examples, the machine learning model can use a random number generator to generate one or more coordinates of a bounding box.

In some cases, the machine learning model 214 can normalize coordinates of the bounding box relative to the image. An example normalization can include setting a coordinate system of the image 202 from 0 to 1 for x-coordinates and −1 to 0 for y-coordinates. In such an example, coordinate (0,0) can represent the top left corner of the image 202, coordinate (1, −1) can represent the bottom right corner of the image 202, coordinate (0.5, −0.5) can represent the center of the image 202, etc. In some examples, a bounding box can include four coordinates (e.g., two x-coordinates and two y-coordinates). The bounding box can represent an area of the image within a box (e.g., rectangle) formed by the four coordinates.

FIG. 2B is a block diagram illustrating a system 200B for performing location modeling. FIG. 2B continues the example of FIG. 2A. FIG. 2B illustrates a first coordinate x₁, or a token associated with the first coordinate, applied as an additional input 222B to inputs 216 of the machine learning model 214. For instance, the machine learning model 214 can generate the first coordinate and can apply the first coordinate as an input to the machine learning model 214 to determine a conditional probability (e.g., second probability 220B) associated with the location of a second coordinate based on the location of the first coordinate. The second probability 220B can be represented as p(y₁|x₁,{bᵢ},c). Element y₁ represents a first y-coordinate of the bounding box.

FIG. 2C is a block diagram illustrating a system 200C for performing location modeling continuing the examples of FIG. 2A and FIG. 2B. FIG. 2C illustrates applying the second coordinate, or a token associated with the second coordinate, as a further additional input 222C to inputs 216. The inputs 216 in FIG. 2C include the visual tokens 210, the object class token 212, the first coordinate of the bounding box, and the second coordinate of the bounding box. Based on the inputs 216, the machine learning model 214 generates a third probability 220C. The third probability 220C is a conditional probability representing the probability associated with the location of a third coordinate based on the location of the first coordinate and the second coordinate. For example, the third probability 220C can be represented as p(x₂|x₁,y₁,{bᵢ},c). Element x₂ represents a second x-coordinate of the bounding box.

FIG. 2D is a block diagram illustrating a system 200D for performing location modeling continuing the examples of FIG. 2A, FIG. 2B, and FIG. 2C. FIG. 2D illustrates applying the third coordinate, or a token associated with the third coordinate, as a further additional input 222D to inputs 216. For example, the machine learning model 214 can generate the fourth coordinate based on the inputs 216 to the machine learning model 214. The inputs 216 of FIG. 2D include the visual tokens 210, the object class token 212, the first coordinate, the second coordinate, and the third coordinate. In some examples, the inputs 216 are a concatenated series of tokens. For example, the inputs 216 can be a concatenated series of tokens with tokens associated with the first coordinate, the second coordinate, and the third coordinate appended after the visual tokens 210 and the object class token 212. In some cases, the object class token 212 immediately precedes tokens associated with the first coordinate, the second coordinate, and the third coordinate, as shown in FIG. 2D. The machine learning model 214 generates a fourth probability 220D representing a conditional probability associated with the location of the fourth coordinate, based on the location of the first coordinate, the location of the second coordinate, and the location of the third coordinate. For example, the fourth probability 220D can be represented as p(y₂|x₁,y₁,x₂,{bᵢ},c). Element y₂ represents a second y-coordinate of the bounding box. Once the fourth coordinate is determined, the bounding box can be output (e.g., with the first, second, third, and fourth coordinates corresponding to the four corners of the bounding box).

In some examples, the machine learning model 214 can generate a histogram associated with the probabilities of locations of coordinates of the bounding boxes. The machine learning model 214 can perform the operations (e.g., generating of probabilities) described in the description of FIGS. 2A-2D for a plurality of coordinates associated with bounding boxes. In some examples, the machine learning model 214 can randomly generate a first coordinate, and perform the operations described in the description of FIGS. 2A-2D based on the random first coordinate. The machine learning model 214 can perform the operations described in the description of FIGS. 2A-2D to populate the histogram with a distribution of probabilities associated with different locations of coordinates of bounding boxes. The machine learning model 214 can select the most probable coordinates based on the histogram or distribution of probabilities populating the histogram (e.g., the coordinates with a highest probability value).

FIG. 2E is a block diagram 200E illustrating example outputs of systems 200A-200D of FIGS. 2A-2D. FIG. 2E illustrates an example bounding box 204E of an image 202. The example bounding box can be the x-y coordinates having the highest probability of being the location with in the 202 where an object can be added as determined using systems 200A-200D. For example, the bounding box can be a pair of x-y coordinates (e.g., (x_1, y_1) and (x_2, y_2)).

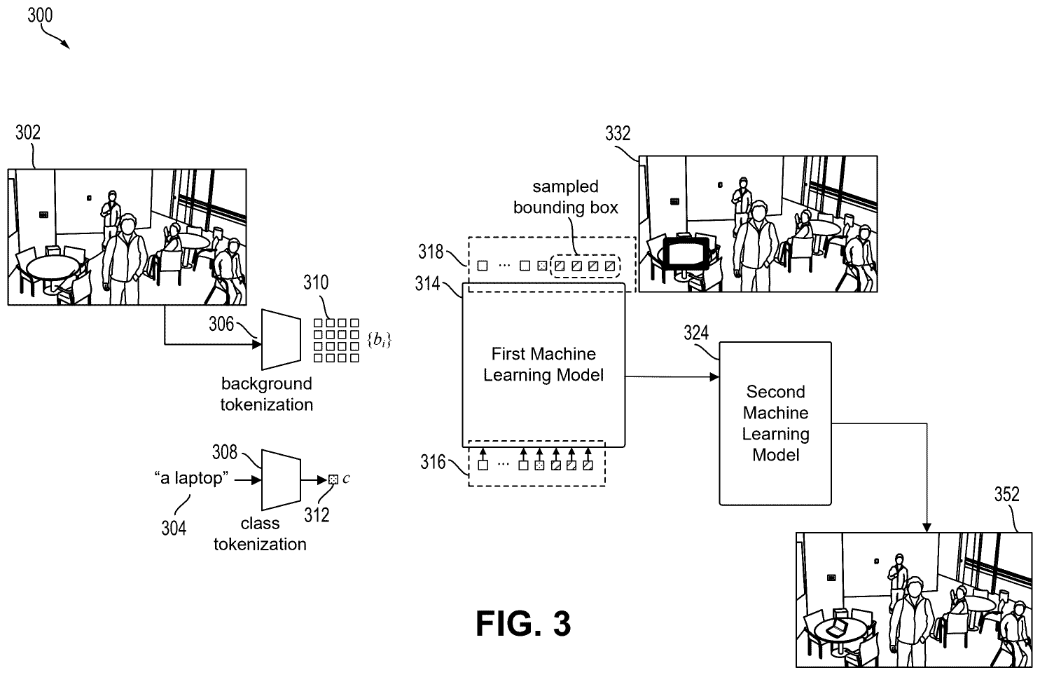

FIG. 2E illustrates a total probability 220E based on the first probability 220A, the second probability 220B, the third probability 220C, and the fourth probability 220D associated with the probability of the location of the pair of x-y coordinates (x_1, y_1) and (x_2, y_2) of the bounding box 204E within the image 202. For example, the total probability 220E can be represented as: p(x₁,y₁,x₁,y₁|{bᵢ},c)=p(y₂|x₁,y₁,x₂,{bᵢ},c)×p(x₂|x₁,y₁,{bᵢ},c)×p(y₁|x₁,{bᵢ},c)×p(x₁|{bᵢ},c) with c representing a class token associated with an object to be added to the image 202 and with {bᵢ} representing visual tokens of the image 202. An inpainting engine or machine learning model (e.g., the inpainting engine 724, the second machine learning model 324 of FIG. 3) can be used to add a visual representation of an object to the image 202 within the bounding box 204E.

FIG. 3 is a block diagram illustrating an example system 300 for adding a visual representation of an object to an image. The system 300 includes a first machine learning model 314, a second machine learning model 324, a first encoder 306, and a second encoder 308. In some examples, the first encoder 306 and the second encoder 308 are part of the first machine learning model 314. In some examples, the first machine learning model is a generative model, such as an autoregressive transformer or a large language model (LLM). In some examples, the second machine learning model is an object placement model using various in-painting techniques or algorithms such as PowerPaint.

The first encoder 306 receives an image 302. The first encoder 306 tokenizes the image 302 to generate visual tokens 310. The visual tokens are a quantized representation of the image. For example, the first encoder 306 can divide the image 302 into non-overlapping sections (or patches) and generate a value representation of the sections. The first encoder 306 can generate a vector associated with the quantized representations of the images (e.g., a vector embedding of the visual tokens).

The second encoder 308 receives an object class selection 304. In some examples, the object class selection 304 is a text selection or text input by a user representing an object the user intends to insert into the image 302. For example, the object class selection 304 can be a word representing the object to be inserted into the image 302 (e.g., laptop or doughnut). The second encoder 208 can tokenize the object class selection 304 to generate an object class token 312. The object class token 312 is a quantized representation of the object class selection 304 such as the one-hot class embedding vector mentioned above.

The first machine learning model 314 can receive the visual tokens 310 and the object class token 312 as inputs 316. The first machine learning model 314 can generate coordinates associated with a bounding box (sampled bounding box) based on the inputs 316. For example, the first machine learning model 314 can generate coordinates by performing the operations further described in the description of FIGS. 2A-2D.

The first machine learning model can generate output 318. The output 318 includes coordinates for a bounding box. For example, the coordinates can include four coordinates such as a first x-coordinate, a second x-coordinate, a first y-coordinate, and a second y-coordinate. The bounding box can be represented as the area of the image within the four coordinates (e.g., a rectangular area). An example bounding box applied to image 302 is illustrated in image 332.

The second machine learning model 324 can receive the output 318, including the visual tokens 310, the object class token 312, and the coordinates generated by the first machine learning model 314. In some examples, the second machine learning model 324 can decode the image 302 from the visual tokens 310 of the output 318. The decoded image can include a bounding box based on the coordinates from the output 318. In further examples, the second machine learning model 324 can receive the image 302 as an input and generate the bounding box based on the coordinates from the output 318.

The second machine learning model 324 can insert an object associated with the object class token 312 into the image 302 within the coordinates of the bounding box. For example, the second machine learning model 324 can perform various in-painting techniques and algorithms to insert the object associated with the object class token 312 into the image 302. Image 352 illustrates an example of a laptop added to the image 302 within the bounding box illustrated in image 332. In some examples, the second machine learning model 324 can receive an image associated with the object class token by querying a repository of images with the object class token 312. The second machine learning model 324 can receive an image of the object from the repository and use in-painting techniques such as PowerPaint to insert the object into the image 302. In some examples, the second machine learning model 324 is further trained to generate images of objects based on the object class token 312.

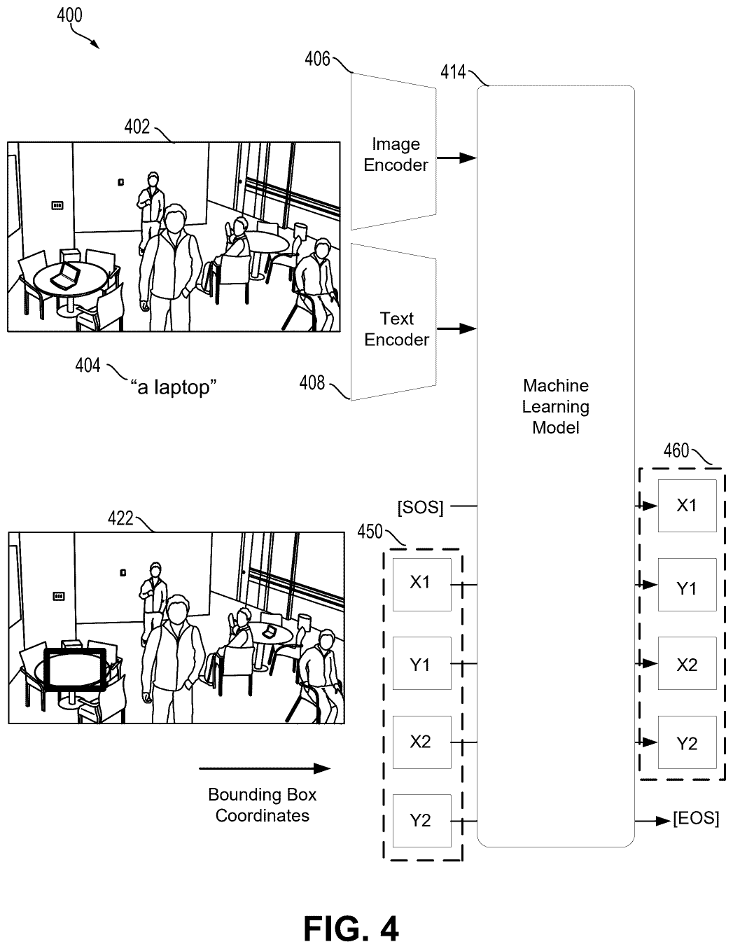

FIG. 4 is a block diagram illustrating an example training system 400 for training a machine learning model 414 for performing location modeling. The terms SOS and EOS refer to start of sequence and end of sequence, respectively. The training system 400 can include an image encoder 406 to receive an image 402 to generate visual tokens associated with the image. The training system 400 can further include a text encoder 408 to receive an object class selection 404 to generate an object class token associated with the object class selection 404.

The machine learning model 414 can receive as inputs the visual tokens, the object tokens, and input coordinates associated with a bounding box. The input coordinates associated with the bounding box can be token representations of coordinates associated with the bounding box in image 422. The parameters of the machine learning model 414 can be fine-tuned so that output coordinates 460 of the machine learning model 414 match the input coordinates 450. In some examples, the parameters of the machine learning model 414 are fine-tuned so that the output coordinates 460 are within an error threshold of the input coordinates. For example, the machine learning model 414 can have an error threshold of 0.05 representing a deviation in location of the output coordinates 460 from the input coordinates 450 of 0.05 (in normalized coordinates).

The machine learning model 414 can be trained to minimize a loss function. For example, the loss function can be represented as a negative log-likelihood objective such as:

$${L}_{train} = - {𝔼}_{( X , Y , C ) ∼ D} {\sum }_{{Y}_{i g} ϵ Y} log [ P ( {Y}_{i}^{{y}_{2}} \vert {Y}_{i}^{{x}_{1} , {y}_{1} , {x}_{2}} X , C ) P ( {Y}_{i}^{{x}_{2}} \vert {Y}_{i}^{{x}_{1} , {y}_{1}} , X , C ) P ( {Y}_{i}^{{y}_{1}} \vert {Y}_{i}^{{x}_{1}} , X , C ) P ( {Y}_{i}^{{x}_{1}} \vert X , C ] .$$

C) P(Yᵢ^{x}^{₁}|X,C)]. In another example, the loss function can be represented as a negative log-likelihood object as:

$${L}_{train} = - {𝔼}_{( X , Y , C ) ∼ D} {\sum }_{{Y}_{i g} ϵ Y} log P ( {Y}_{i}^{{y}_{2}} \vert {Y}_{i}^{{x}_{1} , {y}_{1} {x}_{2}} , X , C ) P ( {Y}_{i}^{{x}_{2}} \vert {Y}_{i}^{{x}_{1} , {y}_{1}} , X , C ) P ( {Y}_{i}^{{y}_{1}} \vert {Y}_{i}^{{x}_{1}} , X , C ) P ( {Y}_{i}^{{x}_{1}} \vert X , C ) .$$

The negative log-likelihood (NLL) objective is a loss function used to measure and compare outputs of the machine learning model 414 to predicted probabilities. Minimizing the output of the NLL objective reduces the difference in predicted probabilities of the machine learning model 414 and the actual outputs of the machine learning model 414.

$${Y}_{i}^{{x}_{1}} , {Y}_{i}^{{x}_{2}} , {Y}_{i}^{{y}_{1}} , and {Y}_{i}^{{y}_{2}}$$

represent top-left and bottom-right corners of a bounding box.

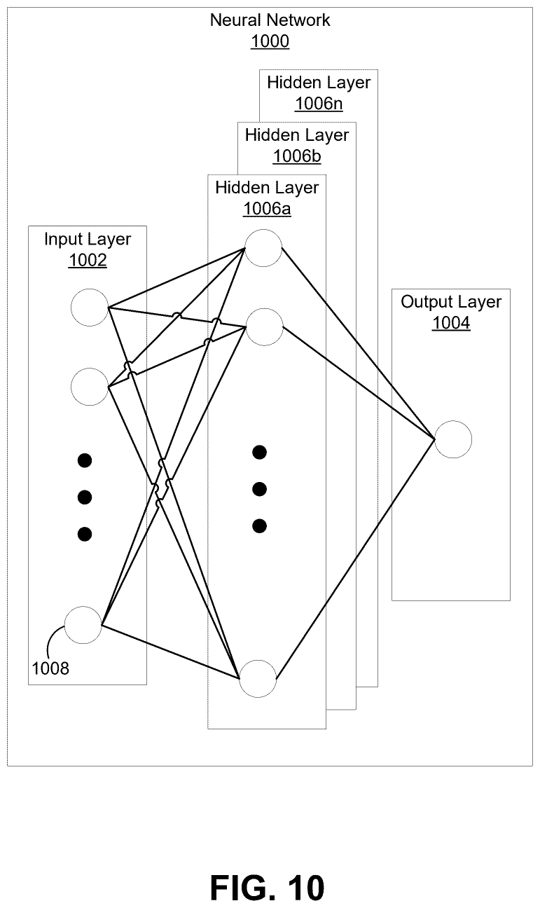

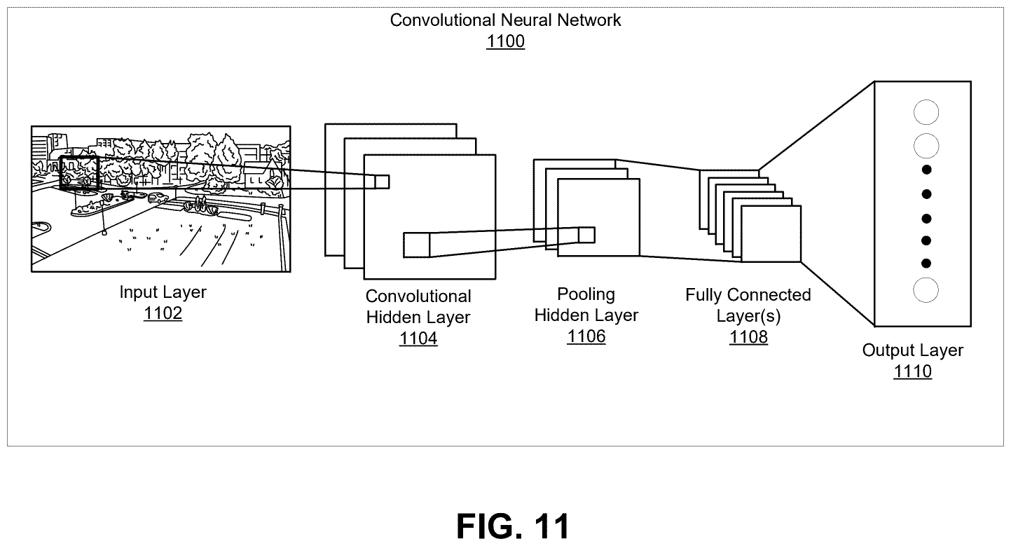

In some aspects, training of one or more of the machine learning systems or neural networks described herein (e.g., such as the machine learning model 214 of FIGS. 2A-2D, the first machine learning model 314 and the second machine learning model 324 of FIG. 3, the neural network 1000 of FIG. 10, the convolutional neural network 1100 of FIG. 11, the transformer 1200 of FIG. 12, among various other machine learning networks described herein) can be performed using online training (e.g., in some case on-device training), offline training, and/or various combinations of online and offline training. In some cases, online may refer to time periods during which the input data (e.g., such as the inputs 316 of FIG. 3, etc.) is processed, for instance for performance of the 3D planar mesh reconstruction processing implemented by the systems and techniques described herein. In some examples, offline may refer to idle time periods or time periods during which input data is not being processed. Additionally, offline may be based on one or more time conditions (e.g., after a particular amount of time has expired, such as a day, a week, a month, etc.) and/or may be based on various other conditions such as network and/or server availability, etc., among various others. In some aspects, offline training of a machine learning model (e.g., a neural network model) can be performed by a first device (e.g., a server device) to generate a pre-trained model, and a second device can receive the pre-trained model from the second device. In some cases, the second device (e.g., a mobile device, an XR device, a vehicle or system/component of the vehicle, or other device) can perform online (or on-device) training of the pre-trained model to further adapt or tune the parameters of the model.

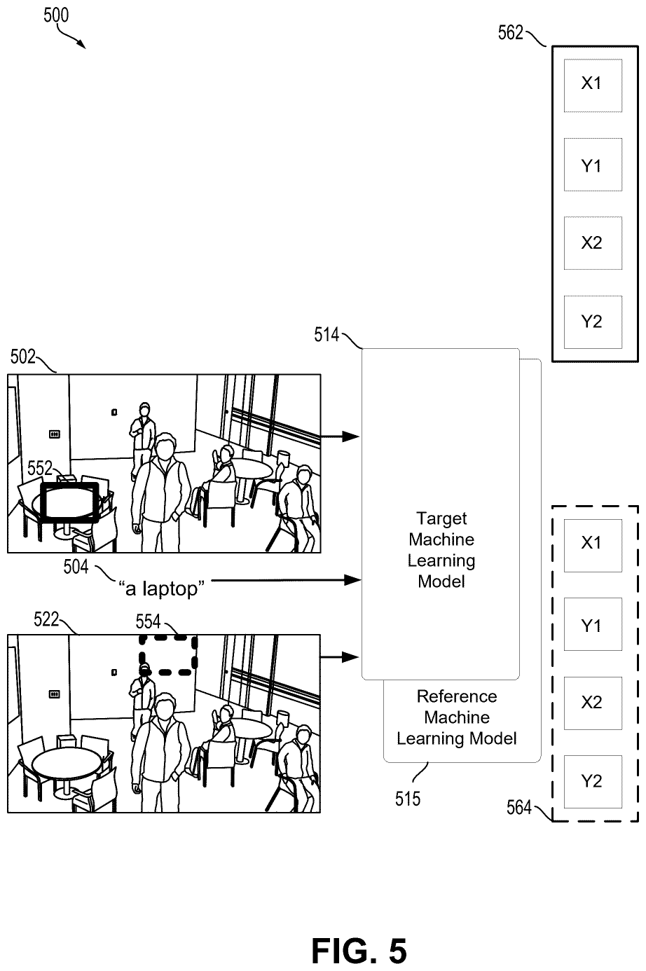

FIG. 5 is a block diagram illustrating an example training system 500 for training a machine learning model for location modeling using preference alignment of bounding box coordinates. The training system 500 can receive coordinates associated with positive bounding boxes (e.g., bounding boxes in which an object could or should be inserted such as bounding box 552) and coordinates associated with negative bounding boxes (e.g., bounding boxes in which an object should not be inserted such as bounding box 554). For example, the bounding box 554 represents an area where an object associated with an object class selection 504 for “laptop” should not be inserted, because image 502 would not look realistic if a laptop was inserted into image 522 on a wall. The bounding box 552 is a positive bounding box, because the bounding box 552 represents a location where an object associated with the object class selection 504 could or should be inserted (e.g., a laptop inserted in image 502 on a table). The image 502 with bounding box 552 and the image 522 with bounding box 554 can represent a preference dataset which the training system 500 can use to derive a preference model.

The training system 500 can fine-tune parameters of a target machine learning model 514 to incentivize generating coordinates 562 associated with bounding box 552 and disincentivize generating coordinates 564 associated with bounding box 554. For example, the training system 500 can use direct preference optimization (DPO) to penalize high logits assigned to negative annotations (e.g., negative bounding boxes).

The training system 500 can use the target machine learning model 514 and a reference machine learning model 515 to derive a preference model. The preference model can be represented as:

$$P ( {Y}^{+} ≻ {Y}^{-} \vert X , C ) = {( 1 + exp ( β log \frac{{π}_{θ} ( {Y}^{-} \vert X , C )}{{π}_{ref} ( {Y}^{-} \vert X , C )} - β log \frac{{π}_{θ} ( {Y}^{+} \vert X , C )}{{π}_{ref} ( {Y}^{+} \vert X , C )} ) )}^{- 1} .$$

Positive bounding box coordinates are represented by Y⁺ and negative bounding box coordinates are represented by Y⁻. Elements π_{θ} and π_{ref} represent logits of the target machine learning model 514 and the reference machine learning model 515 respectively. Element β is a hyperparameter. The training system 500 can fine-tune the target machine learning model 514 to maximize a preference for generating Y⁺ coordinates by optimizing the target machine learning model 514 using a negative log-likelihood objective. For example, the negative log-likelihood (NLL) objective (e.g., a loss function used to optimize the target machine learning model 514) can be represented as:

$${L}_{DPO} = - {𝔼}_{( {Y}^{+} , {Y}^{-} , X , C ) ∼ {D}_{D P O}} [ log σ ( β log \frac{{π}_{θ} ( {Y}^{+} \vert X , C )}{{π}_{ref} ( {Y}^{+} \vert X , C )} - β log \frac{{π}_{θ} ( {Y}^{-} \vert X , C )}{{π}_{ref} ( Y - \vert X , C )} ) ] .$$

In the above equation, D_{DPO} is the dataset used for direct preference optimization (DPO). The D_{DPO} dataset is a dataset that defines, for images X, one or more target locations Y, some of which are positive/preferred (denoted as Y⁺), and some of which are negative/non-preferred (denoted as Y⁻). A goal of the objective is to push the model π_{θ} to take the preferred action more often than the reference model. The two terms within the bracket of the equation are related to the positive and negative locations, respectively. For example, the first term

$$β log \frac{{π}_{θ} ( {Y}^{+} \vert X , C )}{{π}_{ref} ( {Y}^{+} \vert X , C )}$$

is related to maximizing the number of times positive locations are selected, and the second term

$$β log \frac{{π}_{θ} ( {Y}^{-} \vert X , C )}{{π}_{ref} ( {Y}^{-} \vert X , C )}$$

is related to minimizing the number of times negative locations are selected (with respect to a reference model π_{ref} which is frozen during DPO-finetuning).

In further examples, other loss functions or NLL objectives can be used to optimize the target machine learning model 514.

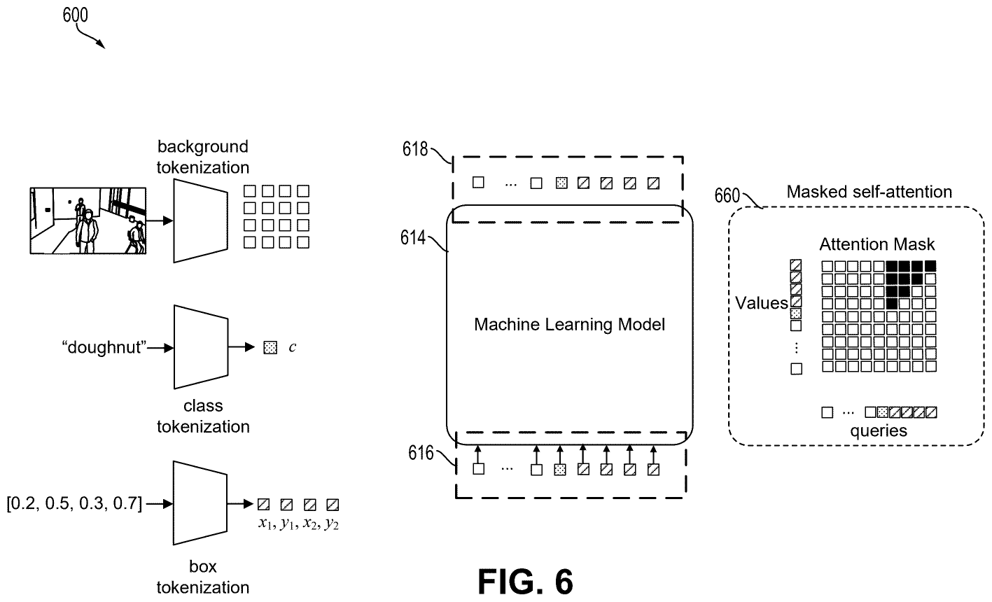

FIG. 6 is a block diagram illustrating another example training system 600 for training a machine learning model 614 for location modeling. The machine learning model 614 can receive as inputs 616 visual tokens associated with an image, an object class token associated with an object to be inserted in the image, and bounding box coordinates. By way of non-limiting example, the machine learning model 614 can be a transformer model, such as the transformer 1200 of FIG. 12. The machine learning model 614 can have a self-attention layer 660. The self-attention layer 660 can be masked for the coordinates of the bounding box because the machine learning model 614 processes the visual tokens and object class token to determine the bounding box coordinates. The machine learning model 614 can be fine-tuned using a loss function so that the masked coordinates of the bounding box match within an error threshold output bounding box coordinates of the machine learning model 614. In some examples, the machine learning model 614 can use autoregressive decoding to predict coordinates of boundary boxes sequentially so that predictions of subsequent coordinates are based in part by the coordinates previously predicted.

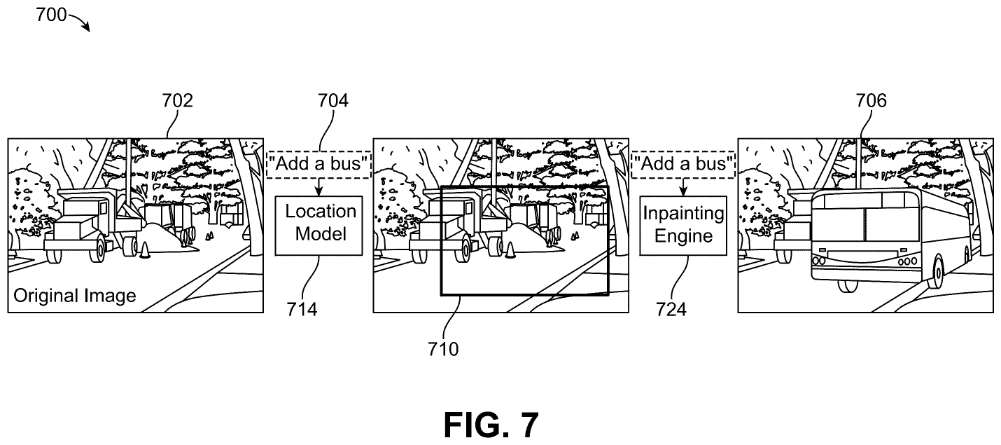

FIG. 7 is a block diagram 700 of another example machine learning model for adding a visual representation of an object to an image. The block diagram 700 includes an image 702, a user prompt 704, a location model 714, an inpainting engine 724, and an edited image 706.

A user can provide the image 702 and the user prompt 704 to the location model 714. The location model can be a machine learning model to determine coordinates of a bounding box used to add a visual representation of an object to the image 702. In some examples, the location model 714 can tokenize the image 702. In further examples, the location model 714 can receive a plurality of tokens representing the image 702. The user prompt 704 can be a request from a user to add an object to the image 702. For example, the user prompt 704 can be a string input (e.g., a sentence or sentence fragment such as “Add a bus”) provided by the user requesting an object be added to the image. In some examples, the location model 714 can be part of an application or computer program with a user interface to which a user can provide input to generate the user prompt 704. In some examples, the location model 714 can determine a class of objects associated with the object the user prompt 704. For example, the user prompt can include a prompt such as “Add a bus”. The location model 714 can determine “bus” is associated with a class of objects, such as vehicles.

The class of objects can be represented as an object class token, as further described in the description of FIGS. 2A-2E. The location model 714 can be a machine learning model to determine coordinates of a bounding box based on the plurality of tokens associated with the image 702 and the object class token associated with the object from the user prompt 704 to be added to the image 702. In some examples, the class token can be the output of a text encoder model such as a CLIP text encoder.

The bounding box coordinates and the user prompt can be received by the inpainting engine 724 to add the object from the user prompt 704 to the image 702. For example, the inpainting engine 724 can be a machine learning model for adding visual representations of objects to an area within a bounding box. The inpainting engine 724 can use various inpainting techniques to add a visual representation of an object to the image within the bounding box such as deep learning-based inpainting (e.g., U-Net Architecture, Generative Adversarial Networks (GANs), etc.) and other learning-based inpainting techniques (e.g., patch matching). In the example where the user prompt 704 is “Add a bus”, the inpainting engine 724 can add a visual representation of a bus within a bounding box determined by the location model 714.

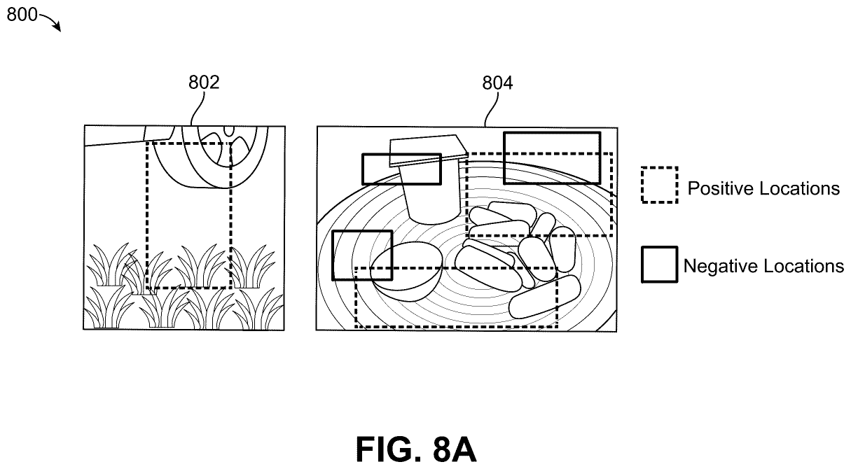

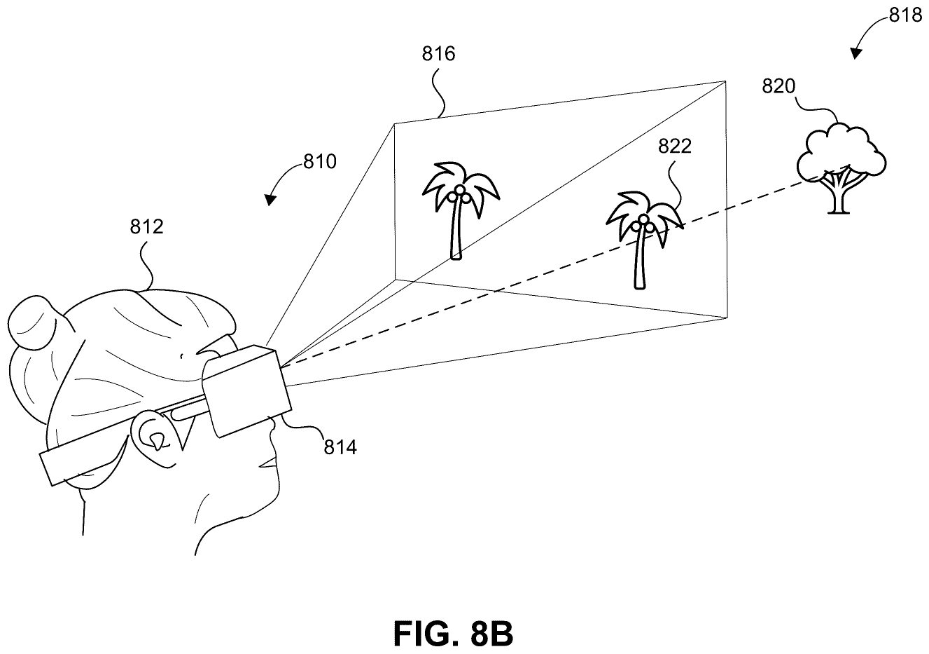

FIG. 8A is a block diagram 800 illustrating an example of annotated images used to train a machine learning model for location modeling (e.g., the machine learning model 214, 414, and 614 of FIGS. 2A-2E, FIG. 4, and FIG. 5; the first machine learning model 314 of FIG. 3; the target machine learning model 514 and the reference machine learning model 515 of FIG. 5; the location model 714 of FIG. 7, etc.). FIG. 8A includes a first annotated image 802 with positive location annotations and a second annotated image 804 with positive location annotations and negative location annotations.

The first annotated image 802 includes only positive location annotations. Positive location annotations can include bounding boxes indicating an area within an image in which an object can be added. In some examples, annotations can be associated with a particular class of object. In further examples, annotations are not associated with a particular class of object. In an example of an annotation associated with a class of object, a first annotation can include a bounding box where an object (e.g., a cat) can be added to an image. A second annotation can include a bounding box where another object (e.g., a banana) can be added to the image. In some examples, annotated images can include multiple positive location annotations associated with different classes of objects (e.g., cat could be associated with a class of animals and a banana could be associated with a class of food).

The second annotated image 804 includes multiple positive location annotations and multiple negative location annotations. Negative location annotations are annotations indicating an area within an image in which an object should not be added. In some examples, the negative location annotations can be associated with a class of objects. In other examples, the negative location annotations are not associated with a class of objects and can indicate a location where no objects should be added to the image. In an example of negative location annotations associated with a class of objects, the negative location annotation can indicate that objects associated with the class should not be added with the area of a bounding box. In some examples, an annotation can be a negative location annotation for a first class of objects and can be a positive location annotation for a second class of objects. For example, a negative location annotation can indicate an area within an image (e.g., defined by a bounding box) where objects associated with a class such as food can be added and an area where objects associated with a class such as animals should not be added.

FIG. 8B is a diagram illustrating an illustrative example of an extended-reality (XR) system 810 that can include a technical application of the systems and techniques described herein. As shown, XR system 810 includes an XR device 814. XR device 814 may implement, as examples, image-capture, object-detection, object-tracking, gaze-tracking, view-tracking, localization (e.g., determining a location of XR device 814), pose-tracking (e.g., tracking a pose of XR device 814), content-generation, content-rendering, computational, communicational, and/or display aspects of extended reality, including virtual reality (VR), augmented reality (AR), and/or mixed reality (MR). Any of such processes or functions can be performed using the machine learning model 214 of FIG. 2A-FIG. 2E, the first machine learning model 314 and/or second machine learning model 324 of FIG. 3, the machine learning model 414 of FIG. 4, the target machine learning model 514 and/or reference machine learning model 515 of FIG. 5, the machine learning model 614 of FIG. 6, or other machine learning model described herein.

For example, XR device 814 may include one or more scene-facing cameras that may capture images of a scene 818 in which a user 812 uses XR device 814. XR device 814 may detect objects (e.g., object 820) in scene 818 based on the images of scene 818. In some aspects, XR device 814 may include one or more user-facing cameras that may capture images of eyes of user 812. XR device 814 may determine a gaze of user 812 based on the images of user 812. In some aspects, XR device 814 may determine an object of interest (e.g., object 820) in scene 818 (e.g., based on the gaze of user 812, based on object recognition, and/or based on a received indication regarding object 820). XR device 814 may obtain and/or render XR content 822 (e.g., text, images, and/or video) for display at XR device 814. XR device 814 may display XR content 822 to user 812 (e.g., within a field of view 816 of user 812). In some aspects, XR content 822 may be based on the object of interest. For example, XR content 822 may be an altered version of object 820. As another example, XR content 822 may appear to interact with object 820. For example, object 820 may be a tree and XR content 822 may include a monkey climbing the tree.

In some aspects, XR device 814 may display XR content 822 in relation to the view of user 812 of the object of interest. For example, XR device 814 may overlay XR content 822 onto object 820 in field of view 816. In any case, XR device 814 may overlay XR content 822 (whether related to object 820 or not) onto the view of user 812 of scene 818. XR device 814 may anchor XR content 822 to object 820, for example, such that as user 812 moves their head (e.g., changing field of view 816), XR content 822 remains in the line of sight between the eyes of user 812 and object 820. To do this, XR device 814 may track a pose of XR device 814 (e.g., based on movement data from one or more inertial measurement units (IMUs) of XR device 814.

In a “see-through” configuration, XR device 814 may include a transparent surface (e.g., optical glass) such that XR content 822 may be displayed on (e.g., by being projected onto) the transparent surface to overlay the view of user 812 of scene 818 as viewed through the transparent surface. In a “passthrough” configuration or a “video see-through” (VST) configuration (e.g., the XR device 814 may be a passthrough AR HMD or glasses), XR device 814 may include a scene-facing camera that may capture images of scene 818. XR device 814 may display images or video of scene 818, as captured by the scene-facing camera, and XR content 822 overlaid on the images or video of scene 818.

In various examples, XR device 814 may be, or may include, a head-mounted device (HMD), a virtual reality headset, and/or smart glasses (e.g., AR glasses). XR device 814 may include one or more cameras, including scene-facing cameras and/or user-facing cameras, a graphics processing unit (GPU), one or more sensors (e.g., such as one or more inertial measurement units (IMUs), image sensors, and/or microphones), one or more communication units (e.g., wireless communication units), and/or one or more output devices (e.g., such as speakers, headphones, displays, and/or smart glass).

The systems and techniques described herein can be used by the XR system 810 in various applications. For example, as noted previously, the XR system 810 may in some aspects include a passthrough AR HMD. In such an example, the systems and techniques described herein may be used by the XR system 810 to add one or more virtual objects into captured images, and may be used to reduce background distortion. A reduced background distortion in turn may reduce a sense of incongruity and dizziness of a user of the passthrough AR HMD.

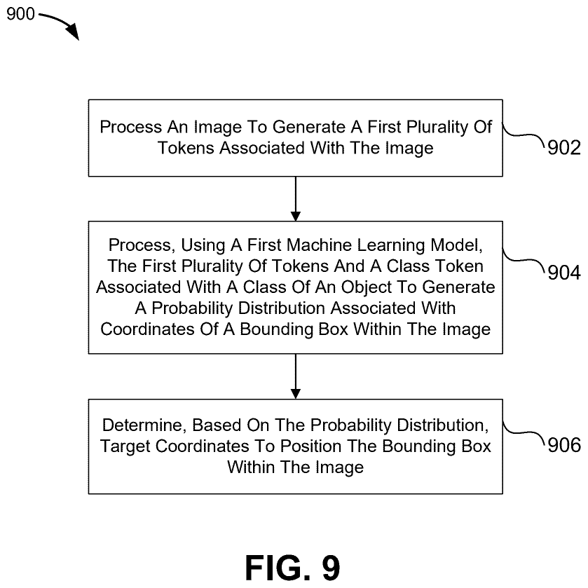

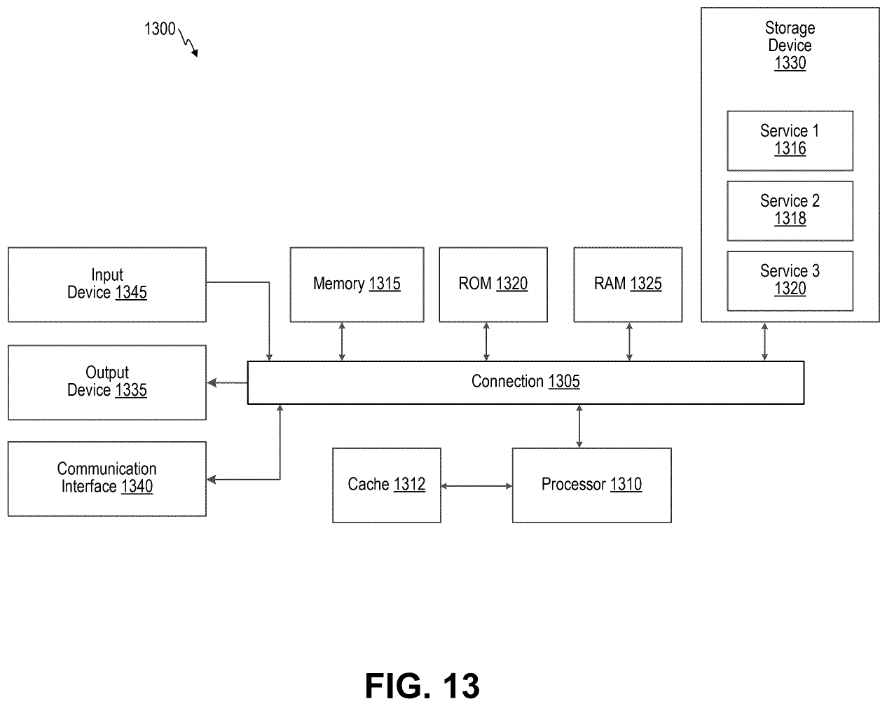

FIG. 9 is a flow diagram illustrating an example process 900 for location modeling via autoregressive decoding, in accordance with aspects of the present disclosure. One or more operations of process 900 can be performed by a computing device (or apparatus) or a component (e.g., the SOC 100 of FIG. 1, any of the systems 200A, 200B, 200C, and/or 200D of FIGS. 2A-2D, the system 300 of FIG. 3, the system 400 of FIG. 4, the system 500 of FIG. 5, the system 600 of FIG. 6, the XR system 810 of FIG. 8B, the computing device architecture 1300 of FIG. 13, one or more chipsets, one or more processors such as one or more central processing units (CPUs), digital signal processors (DSPs), neural processing units (NPUs), neural signal processors (NSPs), microcontrollers, application specific integrated circuits (ASICs), field programmable logic arrays (FPGAs), programmable logic devices, discrete gates or transistor logic components, discrete hardware components, etc., an ML system such as a neural network model, any combination thereof, and/or other component or system) of the computing device. The computing device can be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 can be implemented as software components that are executed and run on one or more processors.

At block 902, the computing device (or component thereof) can process an image to generate a first plurality of tokens associated with the image. For instance, the computing device can utilize an encoder (e.g., the first encoder 206 of FIGS. 2A-2D) to process the image to generate the first plurality of tokens (e.g., the visual tokens 210 of FIGS. 2A-2D). In some aspects, to generate the first plurality of tokens associated with the image, the computing device (or component thereof) can segment the image into patches. In some cases, the patches represent non-overlapping segments of the image.

At block 904, the computing device (or component thereof) can process, using a first machine learning model (e.g., the machine learning model 214 of FIGS. 2A-2D), the first plurality of tokens and a class token associated with a class of an object to generate a probability distribution (e.g., the first probability 220A of FIG. 2A, the second probability 220B of FIG. 2B, the third probability 220C of FIG. 2C, and/or the fourth probability 220D of FIG. 2D) associated with coordinates of a bounding box within the image. In some aspects, the probability distribution is a conditional probability distribution representing a probability each coordinate of the bounding box is located at a location within the image based on a location of other coordinates of the bounding box. In some aspects, the probability distribution is a conditional probability distribution representing a probability each coordinate of the bounding box is located at a location within the image based on the first plurality of tokens and the class token (e.g., p(x₁,y₁,x₂,y₂|{bi},c) as shown in FIG. 2E). In some cases, the probability distribution is a histogram associated with probabilities of one or more corners of the bounding box being placed at one or more coordinates within the image. In some aspects, the first machine learning model can use transformer-based architecture such as a neural network model (e.g., the neural network 1000 of FIG. 10, the convolutional neural network (CNN) 1100 of FIG. 11, the transformer 1200 of FIG. 12, etc.) In some aspects, the computing device (or component thereof) can utilize an encoder (e.g., the second encoder 208 of FIGS. 2A-2D) to process a class indication (e.g., the object class selection 204, which can include a word indicating the class in some examples) to generate the class token (e.g., the class token 212 of FIGS. 2A-2D). In some cases, the computing device (or component thereof) can process a user selection of the object (e.g., corresponding to the object class selection 204 of FIGS. 2A-2D) to generate the class token. In such aspects, the user selection can be represented as a one-hot class embedding vector. For example, the computing device (or component thereof) can receive user input for selecting the object and process the user input to generate the class token. The user input can be represented as a one-hot class embedding vector.

In some aspects, the first machine learning model is a transformer-based neural network model (e.g., an autoregressive transformer model). In some cases, the first machine learning model is trained using training data including a plurality of images with preset bounding boxes associated with one or more class of objects (e.g., as illustrated in any one or more of FIGS. 4-6 and FIG. 8A). In some examples, the training can be on-device training or offline training. In some cases, the computing device (or component thereof), or another computing device, can generate a second plurality of tokens associated with coordinates of at least one bounding box of the preset bounding boxes. In some examples, the second plurality of tokens includes four tokens associated with the at least one bounding box, including a first x-coordinate token, a second x-coordinate token, a first y-coordinate token, and a second y-coordinate token (e.g., as illustrated in any one or more of FIGS. 4-6). In some cases, to generate the probability distribution associated with coordinates of the bounding box within the image, the computing device (or component thereof) can sequentially generate the four tokens associated with the bounding box, including the first x-coordinate token, the second x-coordinate token, the first y-coordinate token, and the second y-coordinate token. In some examples, the computing device (or component thereof) can generate each of the four tokens using the first machine learning model with the first plurality of tokens, the class token associated with the class of the object, and any already generated tokens of the four tokens as inputs. In some aspects, the coordinates of the bounding box are associated with corners of the bounding box. In some cases, at least one class token associated with the at least one bounding box immediately precedes one of the first x-coordinate token or the first y-coordinate token (e.g., as shown in FIG. 6).

At block 906, the computing device (or component thereof) can determine, based on the probability distribution, target coordinates (e.g., the coordinates x₁, y₁, x₂, and y₂ illustrated in FIG. 2D) to position the bounding box within the image. In some aspects, the target coordinates include x-y coordinates of a coordinate system associated with the image.

In some aspects, the computing device (or component thereof) can add a visual representation (e.g., an image, a virtual object, or other visual representation) of the object to the image within the target coordinates of the bounding box. For instance, in some cases, the computing device (or component thereof) can add the visual representation of the object using a second machine learning model (e.g., the second machine learning model 324 of FIG. 3, the inpainting engine 724 of FIG. 7). In some cases, the second machine learning model is an object placement model using in-painting.

In some examples, as noted previously, the methods described herein (e.g., process 900 of FIG. 9 and/or other methods described herein) can be performed, in whole or in part, by a computing device or system. In one example, one or more of the methods can be performed by SOC 100 of FIG. 1, any of the systems 200A, 200B, 200C, and/or 200D of FIGS. 2A-2D, the system 300 of FIG. 3, the system 400 of FIG. 4, the system 500 of FIG. 5, the system 600 of FIG. 6, the computing device architecture 1300 of FIG. 13, any combination thereof, and/or by another computing device or system. In another example, one or more of the processes (e.g., process 900 and/or other process described herein) can be performed, in whole or in part, by a computing device having the computing-device architecture 1300 shown in FIG. 13. For instance, a computing device with the computing-device architecture 1300 shown in FIG. 13 can include, or can be included in, or can be used with the components of the SOC 100 of FIG. 1, any of the systems 200A, 200B, 200C, and/or 200D of FIGS. 2A-2D, the system 300 of FIG. 3, the system 400 of FIG. 4, the system 500 of FIG. 5, the system 600 of FIG. 6, respectively, and can implement the operations of process and/or other process described herein. In some cases, the computing device or apparatus can include various components, such as one or more input devices, one or more output devices, one or more processors, one or more microprocessors, one or more microcomputers, one or more cameras (e.g., configured to capture the image described with respect to the process 900 of FIG. 9), one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 900 and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 900 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

As noted previously, one or more of the systems and techniques described herein can be implemented using a neural network. FIG. 10 is an illustrative example of a neural network 1000 (e.g., a deep-learning neural network) that can be used to implement machine-learning based location modeling via autoregressive decoding, feature segmentation, implicit-neural-representation generation, rendering, classification, object detection, image recognition (e.g., face recognition, object recognition, scene recognition, etc.), feature extraction, authentication, gaze detection, gaze prediction, and/or automation. For example, neural network 1000 can be an example of, or can implement, the first encoder 206 and the second encoder 208 of FIGS. 2A-2D, the first encoder 306 and the second encoder 308 of FIG. 3, etc.

An input layer 1002 includes input data. In one illustrative example, input layer 1002 can include data representing data associated with the image 202 of FIGS. 2A-2D. Neural network 1000 includes multiple hidden layers, for example, hidden layers 1006a, 1006b, through 1006n. The hidden layers 1006a, 1006b, through hidden layer 1006n include “n” number of hidden layers, where “n” is an integer greater than or equal to one. The number of hidden layers can be made to include as many layers as needed for the given application. Neural network 1000 further includes an output layer 1004 that provides an output resulting from the processing performed by the hidden layers 1006a, 1006b, through 1006n. In one illustrative example, output layer 1004 can generate bounding box coordinates and probabilities associated with the bounding box coordinates such as the probabilities 220A-220D of FIGS. 2A-2D.

Neural network 1000 can be, or can include, a multi-layer neural network of interconnected nodes. Each node can represent a piece of information. Information associated with the nodes is shared among the different layers and each layer retains information as information is processed. In some cases, neural network 1000 can include a feed-forward network, in which case there are no feedback connections where outputs of the network are fed back into itself. In some cases, neural network 1000 can include a recurrent neural network, which can have loops that allow information to be carried across nodes while reading in input.

Information can be exchanged between nodes through node-to-node interconnections between the various layers. Nodes of input layer 1002 can activate a set of nodes in the first hidden layer 1006a. For example, as shown, each of the input nodes of input layer 1002 is connected to each of the nodes of the first hidden layer 1006a. The nodes of first hidden layer 1006a can transform the information of each input node by applying activation functions to the input node information. The information derived from the transformation can then be passed to and can activate the nodes of the next hidden layer 1006b, which can perform their own designated functions. Example functions include convolutional, up-sampling, data transformation, and/or any other suitable functions. The output of the hidden layer 1006b can then activate nodes of the next hidden layer, and so on. The output of the last hidden layer 1006n can activate one or more nodes of the output layer 1004, at which an output is provided. In some cases, while nodes (e.g., node 1008) in neural network 1000 are shown as having multiple output lines, a node has a single output and all lines shown as being output from a node represent the same output value.

In some cases, each node or interconnection between nodes can have a weight that is a set of parameters derived from the training of neural network 1000. Once neural network 1000 is trained, it can be referred to as a trained neural network, which can be used to perform one or more operations. For example, an interconnection between nodes can represent a piece of information learned about the interconnected nodes. The interconnection can have a tunable numeric weight that can be tuned (e.g., based on a training dataset), allowing neural network 1000 to be adaptive to inputs and able to learn as more and more data is processed.

Neural network 1000 may be pre-trained to process the features from the data in the input layer 1002 using the different hidden layers 1006a, 1006b, through 1006n in order to provide the output through the output layer 1004. In an example in which neural network 1000 is used to identify features in images, neural network 1000 can be trained using training data that includes both images and labels, as described above. For instance, training images can be input into the network, with each training image having a label indicating the features in the images (for the feature-segmentation machine-learning system) or a label indicating classes of an activity in each image. In one example using object classification for illustrative purposes, a training image can include an image of a number 2, in which case the label for the image can be [0 0 1 0 0 0 0 0 0 0].

In some cases, neural network 1000 can adjust the weights of the nodes using a training process called backpropagation. As noted above, a backpropagation process can include a forward pass, a loss function, a backward pass, and a weight update. The forward pass, loss function, backward pass, and parameter update are performed for one training iteration. The process can be repeated for a certain number of iterations for each set of training images until neural network 1000 is trained well enough so that the weights of the layers are accurately tuned.

For the example of identifying objects in images, the forward pass can include passing a training image through neural network 1000. The weights are initially randomized before neural network 1000 is trained. As an illustrative example, an image can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for neural network 1000, the output will likely include values that do not give preference to any particular class due to the weights being randomly selected at initialization. For example, if the output is a vector with probabilities that the object includes different classes, the probability value for each of the different classes can be equal or at least very similar (e.g., for ten possible classes, each class can have a probability value of 0.1). With the initial weights, neural network 1000 is unable to determine low-level features and thus cannot make an accurate determination of what the classification of the object might be. A loss function can be used to analyze error in the output. Any suitable loss function definition can be used, such as a cross-entropy loss. Another example of a loss function includes the mean squared error (MSE), defined as Eₜₒₜₐₗ=Σ½ (target−output)². The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. Neural network 1000 can perform a backward pass by determining which inputs (weights) most contributed to the loss of the network and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as w=wᵢ−ηdL/dW, where w denotes a weight, w; denotes the initial weight, and n denotes a learning rate. The learning rate can be set to any suitable value, with a high learning rate including larger weight updates and a lower value indicating smaller weight updates.

Neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. Neural network 1000 can include any other deep network other than a CNN, such as an autoencoder, a deep belief nets (DBNs), a Recurrent Neural Networks (RNNs), among others.

FIG. 11 is an illustrative example of a convolutional neural network (CNN) 1100. The input layer 1102 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1104, an optional non-linear activation layer, a pooling hidden layer 1106, and fully connected layer 1108 (which fully connected layer 1108 can be hidden) to get an output at the output layer 1110. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 can be the convolutional hidden layer 1104. The convolutional hidden layer 1104 can analyze image data of the input layer 1102. Each node of the convolutional hidden layer 1104 is connected to a region of nodes (pixels) of the input image called a receptive field. The convolutional hidden layer 1104 can be considered as one or more filters (each filter corresponding to a different activation or feature map), with each convolutional iteration of a filter being a node or neuron of the convolutional hidden layer 1104. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1104. Each connection between a node and a receptive field for that node learns a weight and, in some cases, an overall bias such that each node learns to analyze its particular local receptive field in the input image. Each node of the convolutional hidden layer 1104 will have the same weights and bias (called a shared weight and a shared bias). For example, the filter has an array of weights (numbers) and the same depth as the input. A filter will have a depth of 3 for an image frame example (according to three color components of the input image). An illustrative example size of the filter array is 5×5×3, corresponding to a size of the receptive field of a node.

The convolutional nature of the convolutional hidden layer 1104 is due to each node of the convolutional layer being applied to its corresponding receptive field. For example, a filter of the convolutional hidden layer 1104 can begin in the top-left corner of the input image array and can convolve around the input image. As noted above, each convolutional iteration of the filter can be considered a node or neuron of the convolutional hidden layer 1104. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1104. For example, a filter can be moved by a step amount (referred to as a stride) to the next receptive field. The stride can be set to 1 or any other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1104.

The mapping from the input layer to the convolutional hidden layer 1104 is referred to as an activation map (or feature map). The activation map includes a value for each node representing the filter results at each location of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1104 can include several activation maps in order to identify multiple features in an image. The example shown in FIG. 11 includes three activation maps. Using three activation maps, the convolutional hidden layer 1104 can detect three different kinds of features, with each feature being detectable across the entire image.

In some examples, a non-linear hidden layer can be applied after the convolutional hidden layer 1104. The non-linear layer can be used to introduce non-linearity to a system that has been computing linear operations. One illustrative example of a non-linear layer is a rectified linear unit (ReLU) layer. A ReLU layer can apply the function f(x)=max(0, x) to all of the values in the input volume, which changes all the negative activations to 0. The ReLU can thus increase the non-linear properties of the CNN 1100 without affecting the receptive fields of the convolutional hidden layer 1104.

The pooling hidden layer 1106 can be applied after the convolutional hidden layer 1104 (and after the non-linear hidden layer when used). The pooling hidden layer 1106 is used to simplify the information in the output from the convolutional hidden layer 1104. For example, the pooling hidden layer 1106 can take each activation map output from the convolutional hidden layer 1104 and generates a condensed activation map (or feature map) using a pooling function. Max-pooling is one example of a function performed by a pooling hidden layer. Other forms of pooling functions be used by the pooling hidden layer 1106, such as average pooling, L2-norm pooling, or other suitable pooling functions. A pooling function (e.g., a max-pooling filter, an L2-norm filter, or other suitable pooling filter) is applied to each activation map included in the convolutional hidden layer 1104. In the example shown in FIG. 11, three pooling filters are used for the three activation maps in the convolutional hidden layer 1104.

In some examples, max-pooling can be used by applying a max-pooling filter (e.g., having a size of 2×2) with a stride (e.g., equal to a dimension of the filter, such as a stride of 2) to an activation map output from the convolutional hidden layer 1104. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1104 having a dimension of 24×24 nodes, the output from the pooling hidden layer 1106 will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling) and using the computed values as an output.

The pooling function (e.g., max-pooling, L2-norm pooling, or other pooling function) determines whether a given feature is found anywhere in a region of the image and discards the exact positional information. Discarding the exact positional information can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully connected layer that connects every node from the pooling hidden layer 1106 to every one of the output nodes in the output layer 1110. Using the example above, the input layer includes 28×28 nodes encoding the pixel intensities of the input image, the convolutional hidden layer 1104 includes 3×24×24 hidden feature nodes based on application of a 5×5 local receptive field (for the filters) to three activation maps, and the pooling hidden layer 1106 includes a layer of 3×12×12 hidden feature nodes based on application of max-pooling filter to 2×2 regions across each of the three feature maps. Extending such an example, the output layer 1110 can include ten output nodes. In such an example, every node of the 3×12×12 pooling hidden layer 1106 is connected to every node of the output layer 1110.

The fully connected layer 1108 can obtain the output of the previous pooling hidden layer 1106 (which should represent the activation maps of high-level features) and determines the features that most correlate to a particular class. For example, the fully connected layer 1108 can determine the high-level features that most strongly correlate to a particular class and can include weights (nodes) for the high-level features. A product can be computed between the weights of the fully connected layer 1108 and the pooling hidden layer 1106 to obtain probabilities for the different classes. For example, if the CNN 1100 is being used to predict that an object in an image is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1110 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. A transformer 1200 reduces the operations of learning dependencies by using an encoder 1210 and a decoder 1230 that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, the encoder 1210 is composed of a stack of six identical layers and each layer has two sub-layers. The first sub-layer is a multi-head self-attention engine 1212, and the second sub-layer is a fully-connected feed-forward network 1214. A residual connection (not shown) connects around each of the sub-layers followed by normalization.

In the example transformer 1200, the decoder 1230 is also composed of a stack of six 6 identical layers. The decoder also includes a masked multi-head self-attention engine 1232, a multi-head attention engine 1234 over the output of the encoder 1210, and a fully-connected feed-forward network 1226. Each layer includes a residual connection (not shown) around the layer, which is followed by layer normalization. The masked multi-head self-attention engine 1232 is masked to prevent positions from attending to subsequent positions and ensures that the predictions at position i can depend only on the known outputs at positions less than i (e.g., auto-regression). In some cases, such auto-regression can be utilized in the sequential training/learning described with respect to the systems and techniques described herein (e.g., with respect to FIG. 2A-FIG. 2E).

In the transformer, the queries, keys, and values are linearly projected by a multi-head attention engine into learned linear projects, and then attention is performed in parallel on each of the learned linear projects, which are concatenated and then projected into final values.

The transformer also includes a positional encoder 1240 to encode positions because the model does not contain recurrence and convolution and relative or absolute position of the tokens is needed. In the transformer 1200, the positional encodings are added to the input embeddings at the bottom layer of the encoder 1210 and the decoder 1230. The positional encodings are summed with the embeddings because the positional encodings and embeddings have the same dimensions. A corresponding position decoder 1250 is configured to decode the positions of the embeddings for the decoder 1230.

In some aspects, the transformer 1200 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 1200 can process input sequences of variable length, making it well-suited for natural language processing tasks where input lengths can vary greatly. Additionally, the self-attention mechanism allows the transformer 1200 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 13 illustrates an example computing-device architecture 1300 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1300 can include, implement, or be included in any or all of system 200A-200D of FIGS. 2A-2D, system 300 of FIG. 3, training system 400 of FIG. 4 and/or other devices, modules, or systems described herein. Additionally or alternatively, computing-device architecture 1300 may be configured to perform process 900, and/or other process described herein.

The components of computing-device architecture 1300 are shown in electrical communication with each other using connection 1312, such as a bus. The example computing-device architecture 1300 includes a processing unit (CPU or processor) 1302 and computing device connection 1312 that couples various computing device components including computing device memory 1310, such as read only memory (ROM) 1308 and random-access memory (RAM) 1306, to processor 1302.

Computing-device architecture 1300 can include a cache of high-speed memory connected directly with, in close proximity to, or integrated as part of processor 1302. Computing-device architecture 1300 can copy data from memory 1310 and/or the storage device 1314 to cache 1304 for quick access by processor 1302. In this way, the cache can provide a performance boost that avoids processor 1302 delays while waiting for data. These and other modules can control or be configured to control processor 1302 to perform various actions. Other computing device memory 1310 may be available for use as well. Memory 1310 can include multiple different types of memory with different performance characteristics. Processor 1302 can include any general-purpose processor and a hardware or software service, such as service 1 1316, service 2 1318, and service 3 1320 stored in storage device 1314, configured to control processor 1302 as well as a special-purpose processor where software instructions are incorporated into the processor design. Processor 1302 may be a self-contained system, containing multiple cores or processors, a bus, memory controller, cache, etc. A multi-core processor may be symmetric or asymmetric.

To enable user interaction with the computing-device architecture 1300, input device 1322 can represent any number of input mechanisms, such as a microphone for speech, a touch-sensitive screen for gesture or graphical input, keyboard, mouse, motion input, speech and so forth. Output device 1324 can also be one or more of a number of output mechanisms known to those of skill in the art, such as a display, projector, television, speaker device, etc. In some instances, multimodal computing devices can enable a user to provide multiple types of input to communicate with computing-device architecture 1300. Communication interface 1326 can generally govern and manage the user input and computing device output. There is no restriction on operating on any particular hardware arrangement and therefore the basic features here may easily be substituted for improved hardware or firmware arrangements as they are developed.

Storage device 1314 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1306, read only memory (ROM) 1308, and hybrids thereof. Storage device 1314 can include services 1316, 1318, and 1320 for controlling processor 1302. Other hardware or software modules are contemplated. Storage device 1314 can be connected to the computing device connection 1312. In one aspect, a hardware module that performs a particular function can include the software component stored in a computer-readable medium in connection with the necessary hardware components, such as processor 1302, connection 1312, output device 1324, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for image processing, the apparatus comprising: at least one memory; and at least one processor coupled to the at least one memory and configured to: process an image to generate a first plurality of tokens associated with the image; process, using a first machine learning model, the first plurality of tokens and a class token associated with a class of an object to generate a probability distribution associated with coordinates of a bounding box within the image; and determine, based on the probability distribution, target coordinates to position the bounding box within the image.

Aspect 2. The apparatus of Aspect 1, wherein the at least one processor is configured to: add a visual representation of the object to the image within the target coordinates of the bounding box.

Aspect 3. The apparatus of Aspect 2, wherein the at least one processor is configured to add the visual representation of the object using a second machine learning model.

Aspect 4. The apparatus of any of Aspects 1 to 3, wherein the first machine learning model is a transformer-based neural network model.

Aspect 5. The apparatus of any of Aspects 1 to 4, wherein the first machine learning model is trained using training data including a plurality of images with preset bounding boxes associated with one or more class of objects.

Aspect 6. The apparatus of Aspect 5, wherein the training is on-device training.

Aspect 7. The apparatus of any of Aspects 5 or 6, wherein the at least one processor is configured to: generate a second plurality of tokens associated with coordinates of at least one bounding box of the preset bounding boxes.

Aspect 8. The apparatus of Aspect 7, wherein the second plurality of tokens comprises four tokens associated with the at least one bounding box, including a first x-coordinate token, a second x-coordinate token, a first y-coordinate token, and a second y-coordinate token.

Aspect 9. The apparatus of Aspect 8, wherein at least one class token associated with the at least one bounding box immediately precedes one of the first x-coordinate token or the first y-coordinate token.

Aspect 10. The apparatus of any of Aspects 1 to 9, wherein the at least one processor is configured to: process a user selection of the object to generate the class token, wherein the user selection is represented as a one-hot class embedding vector.

Aspect 11. The apparatus of any of Aspects 1 to 10, wherein the probability distribution is a conditional probability distribution representing a probability each coordinate of the bounding box is located at a location within the image based on a location of other coordinates of the bounding box.

Aspect 12. The apparatus of Aspect 11, wherein the coordinates of the bounding box are associated with corners of the bounding box.

Aspect 13. The apparatus of Aspect 12, wherein the probability distribution is a histogram associated with probabilities of one or more corners of the bounding box being placed at one or more coordinates within the image.

Aspect 14. The apparatus of any of Aspects 1 to 13, wherein the target coordinates include x-y coordinates of a coordinate system associated with the image.

Aspect 15. The apparatus of any of Aspects 1 to 14, further comprising at least one camera configured to capture the image.

Aspect 16. A method for image processing, the method comprising: processing an image to generate a first plurality of tokens associated with the image; processing, using a first machine learning model, the first plurality of tokens and a class token associated with a class of an object to generate a probability distribution associated with coordinates of a bounding box within the image; and determining, based on the probability distribution, target coordinates to position the bounding box within the image.

Aspect 17. The method of Aspect 16, further comprising: adding a visual representation of the object to the image within the target coordinates of the bounding box.

Aspect 18. The method of Aspect 17, further comprising adding the visual representation of the object using a second machine learning model.

Aspect 19. The method of any of Aspects 16 to 18, wherein the first machine learning model is a transformer-based neural network model.

Aspect 20. The method of any of Aspects 16 to 19, wherein the first machine learning model is trained using training data including a plurality of images with preset bounding boxes associated with one or more class of objects.

Aspect 21. The method of Aspect 20, wherein the training is on-device training.

Aspect 22. The method of any of Aspects 20 or 21, further comprising: generating a second plurality of tokens associated with coordinates of at least one bounding box of the preset bounding boxes.

Aspect 23. The method of Aspect 22, wherein the second plurality of tokens comprises four tokens associated with the at least one bounding box, including a first x-coordinate token, a second x-coordinate token, a first y-coordinate token, and a second y-coordinate token.

Aspect 24. The method of Aspect 23, wherein at least one class token associated with the at least one bounding box immediately precedes one of the first x-coordinate token or the first y-coordinate token.

Aspect 25. The method of any of Aspects 16 to 24, further comprising: processing a user selection of the object to generate the class token, wherein the user selection is represented as a one-hot class embedding vector.

Aspect 26. The method of any of Aspects 16 to 25, wherein the probability distribution is a conditional probability distribution representing a probability each coordinate of the bounding box is located at a location within the image based on a location of other coordinates of the bounding box.

Aspect 27. The method of Aspect 26, wherein the coordinates of the bounding box are associated with corners of the bounding box.

Aspect 28. The method of Aspect 27, wherein the probability distribution is a histogram associated with probabilities of one or more corners of the bounding box being placed at one or more coordinates within the image.

Aspect 29. The method of any of Aspects 16 to 28, wherein the target coordinates include x-y coordinates of a coordinate system associated with the image.

Aspect 30. A non-transitory computer-readable medium having stored thereon instructions that, when executed by at least one processor, cause the at least one processor to perform one or more of operations according to any of Aspects 16 to 29

Aspect 31. An apparatus for image processing, comprising means for performing one or more of operations according to any of Aspects 16 to 29.

Aspect 32. An apparatus for image processing, the apparatus comprising: at least one memory; and at least one processor coupled to the at least one memory and configured to: process an image to generate a first plurality of tokens associated with the image; process, using a first machine learning model, the first plurality of tokens and a class token associated with a class of an object to generate a probability distribution associated with coordinates of a bounding box within the image; determine, based on the probability distribution, target coordinates to position the bounding box within the image; and add a visual representation of the object to the image within the target coordinates of the bounding box.

Aspect 33. The apparatus of Aspect 32, wherein, to generate the first plurality of tokens associated with the image, the at least one processor is further configured to segment the image into patches.

Aspect 34. The apparatus of Aspect 33, wherein the patches represent non-overlapping segments of the image.

Aspect 35. The apparatus of any of Aspects 32 to 34, wherein the at least one processor is configured to add the visual representation of the object using a second machine learning model.

Aspect 36. The apparatus of Aspect 35, wherein the second machine learning model is an object placement model using in-painting.

Aspect 37. The apparatus of any of Aspects 32 to 36, wherein the first machine learning model is a transformer-based neural network model.

Aspect 38. The apparatus of Aspect 37, wherein the first machine learning model is an autoregressive transformer model.

Aspect 39. The apparatus of Aspect 38, wherein, to generate the probability distribution associated with coordinates of the bounding box within the image, the at least one processor is further configured to: sequentially generate four tokens associated with the bounding box, including a first x-coordinate token, a second x-coordinate token, a first y-coordinate token, and a second y-coordinate token.

Aspect 40. The apparatus of Aspect 39, wherein the processor is further configured to generate each of the four tokens using the first machine learning model with the first plurality of tokens, the class token associated with the class of the object, and any already generated tokens of the four tokens as inputs.

Aspect 41. The apparatus of any of Aspects 32 to 40, wherein the at least one processor is further configured to: receive user input for selecting the object; and process the user input to generate the class token, wherein the user input is represented as a one-hot class embedding vector.

Aspect 42. The apparatus of any of Aspects 32 to 41, wherein the probability distribution is a conditional probability distribution representing a probability each coordinate of the bounding box is located at a location within the image based on the first plurality of tokens and the class token.

Aspect 43. The apparatus of any of Aspects 32 to 42, further comprising at least one camera configured to capture the image.

Aspect 44. An extended reality device, comprising: the apparatus of any of Aspects 32 to 43; at least one camera configured to capture an image of the real-world environment as the image; and at least one display configured to display a modified image after adding the visual representation of the object to the image within the target coordinates of the bounding box.

Aspect 45. The extended reality device of Aspect 44, wherein the extended reality device is a head-mounted display (HMD) device.

What is claimed is:

1. An apparatus for image processing, the apparatus comprising:
at least one memory; and
at least one processor coupled to the at least one memory and configured to:
process an image to generate a first plurality of tokens associated with the image;
process, using a first machine learning model, the first plurality of tokens and a class token associated with a class of an object to generate a probability distribution associated with coordinates of a bounding box within the image; and
determine, based on the probability distribution, target coordinates to position the bounding box within the image.

2. The apparatus of claim 1, wherein the at least one processor is configured to:
add a visual representation of the object to the image within the target coordinates of the bounding box.

3. The apparatus of claim 2, wherein the at least one processor is configured to add the visual representation of the object using a second machine learning model.

4. The apparatus of claim 1, wherein the first machine learning model is a transformer-based neural network model.

5. The apparatus of claim 1, wherein the first machine learning model is trained using training data including a plurality of images with preset bounding boxes associated with one or more class of objects.

6. The apparatus of claim 5, wherein the training is on-device training.

7. The apparatus of claim 5, wherein the at least one processor is configured to:
generate a second plurality of tokens associated with coordinates of at least one bounding box of the preset bounding boxes.

8. The apparatus of claim 7, wherein the second plurality of tokens comprises four tokens associated with the at least one bounding box, including a first x-coordinate token, a second x-coordinate token, a first y-coordinate token, and a second y-coordinate token.

9. The apparatus of claim 8, wherein at least one class token associated with the at least one bounding box immediately precedes one of the first x-coordinate token or the first y-coordinate token.

10. The apparatus of claim 1, wherein the at least one processor is configured to:
process a user selection of the object to generate the class token, wherein the user selection is represented as a one-hot class embedding vector.

11. The apparatus of claim 1, wherein the probability distribution is a conditional probability distribution representing a probability each coordinate of the bounding box is located at a location within the image based on a location of other coordinates of the bounding box.

12. The apparatus of claim 11, wherein the coordinates of the bounding box are associated with corners of the bounding box.

13. The apparatus of claim 12, wherein the probability distribution is a histogram associated with probabilities of one or more corners of the bounding box being placed at one or more coordinates within the image.

14. The apparatus of claim 1, wherein the target coordinates include x-y coordinates of a coordinate system associated with the image.

15. The apparatus of claim 1, further comprising at least one camera configured to capture the image.

16. A method for determining bounding box coordinates, the method comprising:
processing an image to generate a first plurality of tokens associated with the image;
processing, using a first machine learning model, the first plurality of tokens and a class token associated with a class of an object to generate a probability distribution associated with coordinates of a bounding box within the image; and
determining, based on the probability distribution, target coordinates to position the bounding box within the image.

17. The method of claim 16, further comprising:
adding a visual representation of the object to the image within the target coordinates of the bounding box.

18. The method of claim 17, further comprising adding the visual representation of the object using a second machine learning model.

19. The method of claim 16, wherein the first machine learning model is a transformer-based neural network model.

20. The method of claim 16, wherein the first machine learning model is trained using training data including a plurality of images with preset bounding boxes associated with one or more class of objects.

21. The method of claim 20, wherein the training is on-device training.

22. The method of claim 20, further comprising:
generating a second plurality of tokens associated with coordinates of at least one bounding box of the preset bounding boxes.

23. The method of claim 22, wherein the second plurality of tokens comprises four tokens associated with the at least one bounding box, including a first x-coordinate token, a second x-coordinate token, a first y-coordinate token, and a second y-coordinate token.

24. The method of claim 23, wherein at least one class token associated with the at least one bounding box immediately precedes one of the first x-coordinate token or the first y-coordinate token.

25. The method of claim 16, further comprising:
processing a user selection of the object to generate the class token, wherein the user selection is represented as a one-hot class embedding vector.

26. The method of claim 16, wherein the probability distribution is a conditional probability distribution representing a probability each coordinate of the bounding box is located at a location within the image based on a location of other coordinates of the bounding box.

27. The method of claim 26, wherein the coordinates of the bounding box are associated with corners of the bounding box.

28. The method of claim 27, wherein the probability distribution is a histogram associated with probabilities of one or more corners of the bounding box being placed at one or more coordinates within the image.

29. The method of claim 16, wherein the target coordinates include x-y coordinates of a coordinate system associated with the image.
